(19) United States
(12) Patent Application Publication
(10) Pub. No.: US 2025/0365324 A1
(43) Pub. Date: Nov. 27, 2025

(54) DATA CHANNEL COMMUNICATIONS ASSOCIATED WITH AN INTERNET PROTOCOL MULTIMEDIA SUBSYSTEM

(71) Applicant: QUALCOMM Incorporated, San Diego, CA (US)

(72) Inventors: Kefeng ZHANG, Beijing (CN); Haris ZISIMOPOULOS, London (GB); Carlos Marcelo Dias PAZOS, Carlsbad, CA (US); Yongze CHEN, San Diego, CA (US)

(21) Appl. No.: 18/873,434

(22) PCT Filed: Aug. 10, 2022
(86) PCT No.: PCT/CN2022/111367

§ 371 Date: Dec. 10, 2024

(51) Int. Cl. H04L 65/1069; H04W 72/044; H04W 76/10

(52) U.S. Cl. CPC H04L 65/1069; H04W 72/044; H04W 76/10

(57) ABSTRACT

Various aspects of the present disclosure generally relate to wireless communication. In some aspects, a first network node may obtain a data channel establishment request comprising session description protocol (SDP) information corresponding to a multimedia call session between a first user equipment (UE) and a second UE, the SDP information including a data channel application identifier corresponding to a data channel application. The first network node may provide, to a second network node, a data channel service request that indicates the data channel application identifier. The first network node may obtain, from the second network node, a service response comprising a data channel control policy associated with the data channel application identifier and may allocate, based at least in part on the data channel control policy, media resources corresponding to at least one application data channel. Numerous other aspects are described.

### FIELD OF THE DISCLOSURE

Aspects of the present disclosure generally relate to an internet protocol multimedia subsystem (IMS) and, for example, to data channel communications associated with an IMS.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful. Some of those improvements involve improvements to services that facilitate communications between network nodes associated with a telecommunication network such as, for example, internet protocol multimedia subsystems (IMSs). IMSs facilitate multimedia content transmission, reception, and delivery through a network.

### SUMMARY

Some aspects described herein relate to a first network node for wireless communication. The first network node may include a memory and one or more processors coupled to the memory. The one or more processors may be configured to obtain a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment. The one or more processors may be configured to provide, to a second network node, a data channel service request that indicates the data channel application identifier. The one or more processors may be configured to obtain, from the second network node, a service response comprising a data channel control policy associated with the data channel application identifier. The one or more processors may be configured to allocate, based at least in part on the data channel control policy, media resources corresponding to at least one application data channel and associated with the first user equipment and the second user equipment.

Some aspects described herein relate to a first network node for wireless communication. The first network node may include a memory and one or more processors coupled to the memory. The one or more processors may be configured to obtain, from a second network node, a data channel application identifier corresponding to a data channel application associated with a multimedia call session between a first user equipment and a second user equipment. The one or more processors may be configured to provide, to the first user equipment, the data channel application identifier based on the first user equipment obtaining a first instance of the data channel application.

Some aspects described herein relate to a first user equipment for wireless communication. The first user equipment may include a memory and one or more processors coupled to the memory. The one or more processors may be configured to provide, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment. The one or more processors may be configured to obtain, from the first network node, an allocation of media resources corresponding to at least one application data channel and associated with the first user equipment and the second user equipment, wherein the allocation is based on a data channel control policy associated with the data channel application identifier.

Some aspects described herein relate to a second user equipment associated with a multimedia call session between a first user equipment and the second user equipment. The second user equipment associated with a multimedia call session between a first user equipment and the second user equipment may include a memory and one or more processors coupled to the memory. The one or more processors may be configured to obtain, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment. The one or more processors may be configured to communicate data channel traffic via at least one application data channel between the first user equipment and the second user equipment. The one or more processors may be configured to associate the data channel traffic with the data channel application identifier.

Some aspects described herein relate to a method of wireless communication performed by a first network node. The method may include obtaining a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment. The method may include providing, to a second network node, a data channel service request that indicates the data channel application identifier. The method may include obtaining, from the second network node, a service response comprising a data channel control policy associated with the data channel application identifier. The method may include allocating, based at least in part on the data channel control policy, media resources corresponding to at least one application data channel and associated with the first user equipment and the second user equipment.

Some aspects described herein relate to a method of wireless communication performed by a first network node. The method may include obtaining, from a second network node, a data channel application identifier corresponding to a data channel application associated with a multimedia call session between a first user equipment and a second user equipment. The method may include providing, to the first user equipment, the data channel application identifier based on the first user equipment obtaining a first instance of the data channel application.

Some aspects described herein relate to a method of wireless communication performed by a first user equipment. The method may include providing, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment. The method may include obtaining, from the first network node, an allocation of media resources corresponding to at least one application data channel and associated with the first user equipment and the second user equipment, wherein the allocation is based on a data channel control policy associated with the data channel application identifier.

Some aspects described herein relate to a method of wireless communication performed by a second user equipment and associated with a multimedia call session between a first user equipment and the second user equipment. The method may include obtaining, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment. The method may include communicating data channel traffic via at least one application data channel between the first user equipment and the second user equipment. The method may include associating the data channel traffic with the data channel application identifier.

Some aspects described herein relate to a non-transitory computer-readable medium that stores a set of instructions for wireless communication by a first network node. The set of instructions, when executed by one or more processors of the first network node, may cause the first network node to obtain a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment. The set of instructions, when executed by one or more processors of the first network node, may cause the first network node to provide, to a second network node, a data channel service request that indicates the data channel application identifier. The set of instructions, when executed by one or more processors of the first network node, may cause the first network node to obtain, from the second network node, a service response comprising a data channel control policy associated with the data channel application identifier. The set of instructions, when executed by one or more processors of the first network node, may cause the first network node to allocate, based at least in part on the data channel control policy, media resources corresponding to at least one application data channel and associated with the first user equipment and the second user equipment.

Some aspects described herein relate to a non-transitory computer-readable medium that stores a set of instructions for wireless communication by a first network node. The set of instructions, when executed by one or more processors of the first network node, may cause the first network node to obtain, from a second network node, a data channel application identifier corresponding to a data channel application associated with a multimedia call session between a first user equipment and a second user equipment. The set of instructions, when executed by one or more processors of the first network node, may cause the first network node to provide, to the first user equipment, the data channel application identifier based on the first user equipment obtaining a first instance of the data channel application.

Some aspects described herein relate to a non-transitory computer-readable medium that stores a set of instructions for wireless communication by a first user equipment. The set of instructions, when executed by one or more processors of the first user equipment, may cause the first user equipment to provide, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment. The set of instructions, when executed by one or more processors of the first user equipment, may cause the first user equipment to obtain, from the first network node, an allocation of media resources corresponding to at least one application data channel and associated with the first user equipment and the second user equipment, wherein the allocation is based on a data channel control policy associated with the data channel application identifier.

Some aspects described herein relate to a non-transitory computer-readable medium that stores a set of instructions for wireless communication by a second user equipment associated with a multimedia call session between a first user equipment and the second user equipment. The set of instructions, when executed by one or more processors of the second user equipment associated with a multimedia call session between a first user equipment and the second user equipment, may cause the second user equipment associated with a multimedia call session between a first user equipment and the second user equipment to obtain, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment. The set of instructions, when executed by one or more processors of the second user equipment associated with a multimedia call session between a first user equipment and the second user equipment, may cause the second user equipment associated with a multimedia call session between a first user equipment and the second user equipment to communicate data channel traffic via at least one application data channel between the first user equipment and the second user equipment. The set of instructions, when executed by one or more processors of the second user equipment associated with a multimedia call session between a first user equipment and the second user equipment, may cause the second user equipment associated with a multimedia call session between a first user equipment and the second user equipment to associate the data channel traffic with the data channel application identifier.

Some aspects described herein relate to an apparatus for wireless communication. The apparatus may include means for obtaining a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment. The apparatus may include means for providing, to a second network node, a data channel service request that indicates the data channel application identifier. The apparatus may include means for obtaining, from the second network node, a service response comprising a data channel control policy associated with the data channel application identifier. The apparatus may include means for allocating, based at least in part on the data channel control policy, media resources corresponding to at least one application data channel and associated with the first user equipment and the second user equipment.

Some aspects described herein relate to an apparatus for wireless communication. The apparatus may include means for obtaining, from a second network node, a data channel application identifier corresponding to a data channel application associated with a multimedia call session between a first user equipment and a second user equipment. The apparatus may include means for providing, to the first user equipment, the data channel application identifier based on the first user equipment obtaining a first instance of the data channel application.

Some aspects described herein relate to an apparatus for wireless communication. The apparatus may include means for providing, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment. The apparatus may include means for obtaining, from the first network node, an allocation of media resources corresponding to at least one application data channel and associated with the first user equipment and the second user equipment, wherein the allocation is based on a data channel control policy associated with the data channel application identifier.

Some aspects described herein relate to an apparatus for wireless communication. The apparatus may include means for obtaining, from a first network node, a data channel service request comprising session description protocol information corresponding to a multimedia call session, the session description protocol information indicating media description information associated with the multimedia call session, wherein the media description information includes a data channel application identifier corresponding to a data channel application associated with a user equipment. The apparatus may include means for communicating data channel traffic via at least one application data channel between the user equipment and the apparatus. The apparatus may include means for associating the data channel traffic with the data

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which apparatuses and/or methods described herein may be implemented, in accordance with the present disclosure.

FIG. 2 is a diagram of example components of an apparatus, in accordance with the present disclosure.

FIG. 3 is a diagram illustrating an example of a wireless network, in accordance with the present disclosure.

FIG. 4 is a diagram illustrating an environment including a network node in wireless communication with a network node (e.g., via a network such as the network depicted in FIG. 1 and/or the wireless network depicted in FIG. 3), in accordance with the present disclosure.

FIG. 5 is a diagram illustrating an example disaggregated base station architecture, in accordance with the present disclosure.

FIG. 6 is a diagram illustrating an example of a service-based architecture for providing a data channel associated with an internet protocol multimedia subsystem (IMS), in accordance with the present disclosure.

FIG. 7 is a diagram illustrating an example associated with data channel communications associated with an IMS, in accordance with the present disclosure.

FIG. 8 is a diagram illustrating an example process performed, for example, by a first network node, in accordance with the present disclosure.

FIG. 9 is a diagram illustrating an example process performed, for example, by a first network node, in accordance with the present disclosure.

FIG. 10 is a diagram illustrating an example process performed, for example, by a first user equipment, in accordance with the present disclosure.

FIG. 11 is a diagram illustrating an example process performed, for example, by a second user equipment, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

An Internet protocol multimedia subsystem (IMS) architecture facilitates development and deployment of multiple types of multimedia services. Some considerations addressed by IMSs include interoperability, end-to-end service, and security. IMS has been positioned on top of network layers to make it access and device independent-that is, IMS services may be implemented on a variety of different end user devices, including mobile phones, personal computers, set top boxes, and/or modems, among other examples.

The IMS architecture allows operators to offer carrier grade services to be offered on packet-switched networks. Examples of services that have been standardized on top of IMS include Open Mobile Alliance (OMA) presence and group list management, Push-to-Talk over Cellular (PoC), Instant Messaging, and TISPAN/3GPP multimedia telephony for IMS (MMTel). Other IMS services that have been developed for deployment as next-generation LTE services include Voice over LTE (VoLTE) and Video Telephony (VT). Services such as VOLTE may be particularly beneficial by allowing a device to camp on LTE service for both voice and data communications, instead of requiring a switch or fallback to a circuit-switched network.

Other applications have been developed that provide carrier grade data services controlled by operators. For example, the Rich Communications Suite (RCS) is an applications suite that provides carrier grade video and file sharing, instant messaging, and other data applications using IP-based solutions that are compatible across devices and networks. For example, enhanced messaging services generally provide a large number of messaging options including chat, location sharing, and file sharing, and enhanced calling services generally provide multimedia content sharing during a voice call, and video calling.

IMS data channel functionality can support a variety of media types between two end points (e.g., between two user equipment (UEs)). The media delivered via a data channel may be standardized or customized for specific data channel applications. Multiple data channels can be established simultaneously for a data channel multimedia telephony service for IMS (DCMTSI) UE for traffic delivery of different data channel applications. To facilitate effective functionality of a data channel application, the IMS network can determine the quality of service (QoS) requirement for the media types to be delivered in the data channels and authorize the correlated bearer resource in an IP-connectivity access network (CAN). However, the QoS requirements for the media type may correspond to a data channel application, and the IMS network may not be aware of which data channel application the media type corresponds to. Moreover, a data channel server can be unaware of the data channel application to be utilized in a data channel and, as a result, can be unable to determine a proper data channel control policy to be used. Similarly, without identification information associated with a data channel application being shared between UEs, there may be no effective mechanism for synchronizing data application usage between the UEs.

Data channel applications can be downloaded, by UEs, from a data channel application repository (DCAR). Data channel applications can be web-based applications that can be executed in a web environment. A data channel application identifier (ID) may be associated with a data channel application, but typically is not reflected in session data protocol (SDP) media descriptions of data channels. Some aspects described herein may facilitate using a data channel application ID to support appropriate data channel control and synchronizing across a data channel and between UEs. In this way, some aspects may support integration of data channels in IMS session calls, thereby improving the offerings of wireless communications and having a positive impact on network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

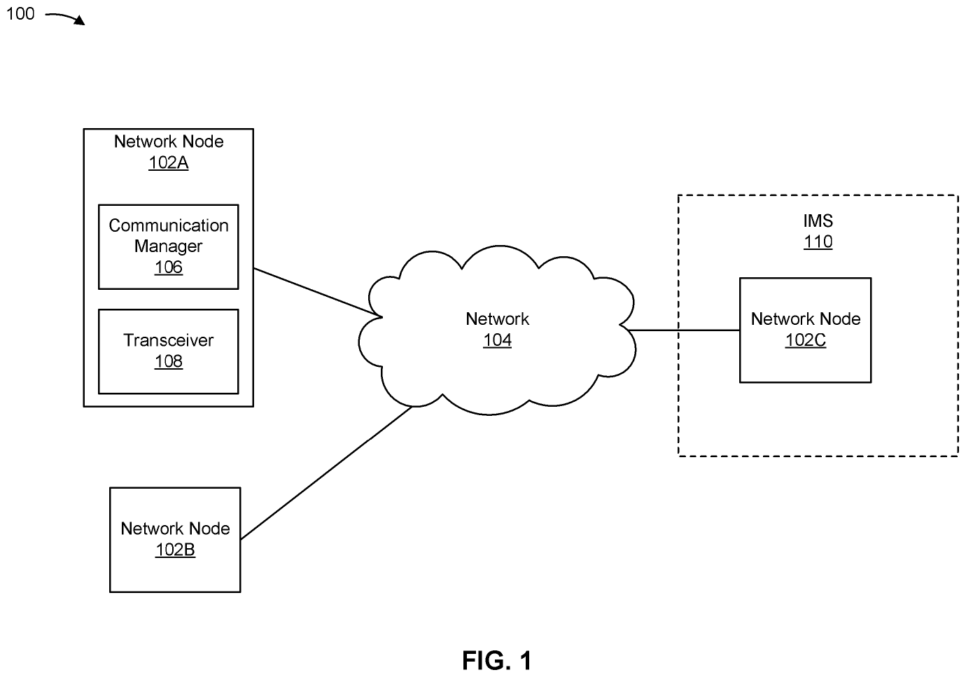

FIG. 1 is a diagram illustrating an example environment 100 in which apparatuses and/or methods described herein may be implemented, in accordance with the present disclosure. As shown in FIG. 1, the environment 100 may include a network node 102A, a network node 102B, and a network node 102C, that may communicate with one another via a network 104. The network nodes 102A, 102B, and 102C may be dispersed throughout the network 104, and each network node 102A, 102B, and 102C may be stationary and/or mobile. The network 104 may include wired communication connections, wireless communication connections, or a combination of wired and wireless communication connections.

The network 104 may include, for example, a cellular network (e.g., a Long-Term Evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

In general, any number of networks 104 may be deployed in a given geographic area. Each network 104 may support a particular radio access technology (RAT) and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, Open-RAT, New Radio (NR) or 5G RAT networks may be deployed.

In some aspects, the environment 100 may include one or more non-terrestrial network (NTN) deployments in which a non-terrestrial wireless communication device may include a non-terrestrial network node (e.g., the network node 102A, 102B, and/or 102C). The non-terrestrial network node may include a network node such as, for example, a user equipment (UE) (which may be referred to herein, interchangeably, as a “non-terrestrial UE”), a base station (referred to herein, interchangeably, as a “non-terrestrial BS” and “non-terrestrial base station”), and/or a relay station (referred to herein, interchangeably, as a “non-terrestrial relay station”), among other examples. As used herein, “NTN” may refer to a network for which access is facilitated by a non-terrestrial network node such as a non-terrestrial UE, a non-terrestrial base station, and/or a non-terrestrial relay station, among other examples.

One or more of the network nodes 102A, 102B, and 102C may be, include, or be included in, any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, a high elliptical orbit (HEO) satellite, and/or the like. A manned aircraft system may include an airplane, helicopter, a dirigible, and/or the like. A UAS platform may include a high-altitude platform station (HAPS), and may include a balloon, a dirigible, an airplane, and/or the like. Satellites may communicate directly and/or indirectly with other entities in the environment using satellite communication. The other entities may include UEs (e.g., terrestrial UEs and/or non-terrestrial UEs), other satellites in the one or more NTN deployments, other types of base stations (e.g., stationary and/or ground-based BSs), relay stations, and/or one or more components and/or devices included in a core network, among other examples.

As described herein, a network node (which may alternatively be referred to as a node, a network entity, or a wireless node) may be, be similar to, include, or be included in (e.g., be a component of) a base station (e.g., any base station described herein, including a disaggregated base station), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity.

The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. As an example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples.

Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

As shown, the network node 102A may include a communication manager 106 and a transceiver 108. The communication manager 106 may be configured to perform one or more communication tasks as described herein. In some aspects, the communication manager 106 may direct the transceiver 108 to perform one or more communication tasks as described herein. Although depicted, for clarity of description, with reference only to the network node 102A, any one or more of the network nodes 102B and 102C also may include a communication manager and a transceiver. For example, as shown, the network node 102C may be one of any number of network nodes implemented as a component of an IMS, and may include a communication manager and/or a transceiver with which the network node 102C may communicate with one or more other network nodes implemented within the IMS and/or the network nodes 102A and/or 102B.

In some aspects, a first network node 102A may include a communication manager 106. As described in more detail elsewhere herein, the communication manager 106 may obtain a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment; provide, to a second network node, a data channel service request that indicates the data channel application identifier; obtain, from the second network node, a service response comprising a data channel control policy associated with the data channel application identifier; and allocate, based at least in part on the data channel control policy, media resources corresponding to at least one application data channel and associated with the first user equipment and the second user equipment.

In some aspects, the communication manager 106 may obtain, from a second network node, a data channel application identifier corresponding to a data channel application associated with a multimedia call session between a first user equipment and a second user equipment; and provide, to the first user equipment, the data channel application identifier based on the first user equipment obtaining a first instance of the data channel application.

In some aspects, the communication manager 106 may provide, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment; and obtain, from the first network node, an allocation of media resources corresponding to at least one application data channel and associated with the first user equipment and the second user equipment, wherein the allocation is based on a data channel control policy associated with the data channel application identifier.

In some aspects, the communication manager 106 may obtain, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment; communicate data channel traffic via at least one application data channel between the first user equipment and the second user equipment; and associate the data channel traffic with the data channel application identifier. Additionally, or alternatively, the communication manager 106 may perform one or more other operations described herein.

The number and arrangement of entities shown in FIG. 1 are provided as one or more examples. In practice, there may be additional network nodes and/or networks, fewer network nodes and/or networks, different network nodes and/or networks, or differently arranged network nodes and/or networks than those shown in FIG. 1. Furthermore, the network node 102A, 102B, and/or 102C may be implemented using a single apparatus or multiple apparatuses.

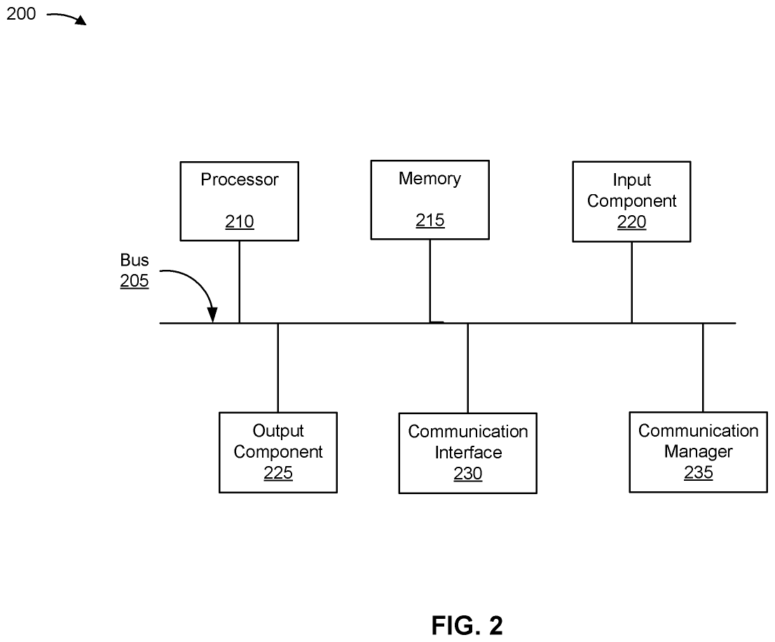

FIG. 2 is a diagram of example components of an apparatus 200, in accordance with the present disclosure. The apparatus 200 may correspond to any one or more of the network nodes 102A, 102B, and/or 102C. Additionally, or alternatively, any one or more of the network nodes 102A, 102B, and/or 102C may include one or more apparatuses 200 and/or one or more components of the apparatus 200. For example, in some aspects, the apparatus 200 may include an apparatus (e.g., a device, a device component, a modem, a chip, and/or a set of device components, among other examples) that is configured to perform a wireless communication method, as described herein. As shown in FIG. 2, the apparatus 200 may include components such as a bus 205, a processor 210, a memory 215, an input component 220, an output component 225, a communication interface 230, and a communication manager 235. Any one or more of the components 205, 210, 215, 220, 225 230, and/or 235 may be implemented in hardware, software, or a combination of hardware and software.

The bus 205 includes a component that permits communication among the components of the apparatus 200. The processor 210 includes a central processing unit (CPU), a graphics processing unit (GPU), an accelerated processing unit (APU), a digital signal processor (DSP), a microprocessor, a microcontroller, a field-programmable gate array (FPGA), an application-specific integrated circuit (ASIC), and/or another type of processing component. In some aspects, the processor 210 includes one or more processors capable of being programmed to perform a function.

The memory 215 includes a random-access memory (RAM), a read only memory (ROM), and/or another type of dynamic or static storage device (e.g., a flash memory, a magnetic memory, and/or an optical memory) that stores information and/or instructions for use by the processor 210. The memory 215 may store other information and/or software related to the operation and use of the apparatus 200. For example, the memory 215 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium.

The input component 220 includes a component that permits the apparatus 200 to receive information, such as via user input. For example, the input component 220 may be associated with a user interface as described herein (e.g., to permit a user to interact with the one or more features of the apparatus 200). The input component 220 may include a capacitive touchscreen display that can receive user inputs. The input component 220 may include a keyboard, a keypad, a mouse, a button, a switch, and/or a microphone, among other examples. Additionally, or alternatively, the input component 220 may include a sensor for sensing information (e.g., a vision sensor, a location sensor, an accelerometer, a gyroscope, and/or an actuator, among other examples). In some aspects, the input component 220 may include a camera (e.g., a high-resolution camera and/or a low-resolution camera, among other examples). The output component 225 may include a component that provides output from the apparatus 200 (e.g., a display, a speaker, and/or one or more light-emitting diodes (LEDs), among other examples).

The communication interface 230 may include a transmission component and/or a reception component. For example, the communication interface 230 may include a transceiver and/or one or more separate receivers and/or transmitters that enable the apparatus 200 to communicate with other devices, such as via a wired connection, a wireless connection, or a combination of wired and wireless connections. In some aspects, the communication interface may include one or more radio frequency reflective elements and/or one or more radio frequency refractive elements. The communication interface 230 may permit the apparatus 200 to receive information from another apparatus and/or provide information to another apparatus. For example, the communication interface 230 may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

The communication manager 235 may include hardware, software, or a combination of hardware and software configured to cause the apparatus 200 to perform one or more communication tasks associated with the communication manager 106 and/or the transceiver 108. In some aspects, the communication manager 235 may be, be similar to, include, or be included in, the communication manager 106 depicted in FIG. 1. In some aspects, the communication manager 235 may include the processor 210, the memory 215, the input component 220, the output component 225, the communication interface 230, and/or one or more aspects thereof.

As indicated above, FIG. 2 is provided as an example. Other examples may differ from what is described with regard to FIG. 2.

As described above, in some aspects, the network 108 depicted in FIG. 1 may include a cellular network that includes a RAT. While some aspects may be described herein using terminology commonly associated with a 5G or NR RAT, aspects of the present disclosure can be applied to other RATs, such as a 3G RAT, a 4G RAT, and/or a RAT subsequent to 5G (e.g., 6G).

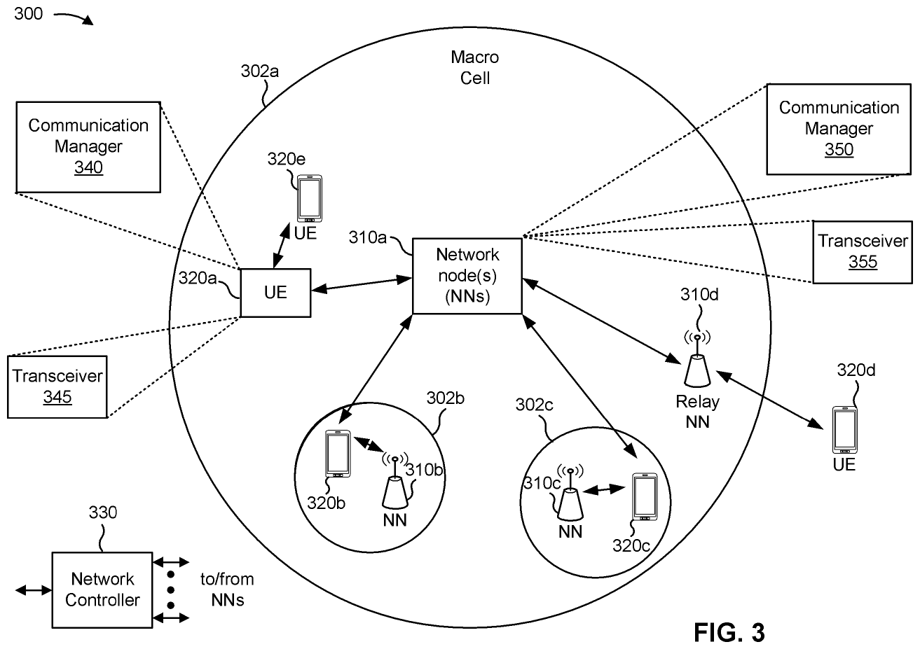

FIG. 3 is a diagram illustrating an example of a wireless network 300, in accordance with the present disclosure. The wireless network 300 may be or may include elements of a 5G (e.g., NR) network and/or a 4G (e.g., LTE) network, among other examples. The wireless network 300 may include one or more network nodes 310 (shown as a network node 310a, a network node 310b, a network node 310c, and a network node 310d), a UE 320 or multiple UEs 320 (shown as a UE 320a, a UE 320b, a UE 320c, a UE 320d, and a UE 320e), and/or other entities. A network node 310 is a network node that communicates with UEs 320. As shown, a network node 310 may include one or more network nodes. For example, a network node 310 may be an aggregated network node, meaning that the aggregated network node is configured to utilize a radio protocol stack that is physically or logically integrated within a single radio access network (RAN) node (e.g., within a single device or unit). As another example, a network node 310 may be a disaggregated network node (sometimes referred to as a disaggregated base station), meaning that the network node 310 is configured to utilize a protocol stack that is physically or logically distributed among two or more nodes (such as one or more CUs, one or more DUs, or one or more RUs).

In some examples, a network node 310 is or includes a network node that communicates with UEs 320 via a radio access link, such as an RU. In some examples, a network node 310 is or includes a network node that communicates with other network nodes 310 via a fronthaul link or a midhaul link, such as a DU. In some examples, a network node 310 is or includes a network node that communicates with other network nodes 310 via a midhaul link or a core network via a backhaul link, such as a CU. In some examples, a network node 310 (such as an aggregated network node 310 or a disaggregated network node 310) may include multiple network nodes, such as one or more RUs, one or more CUs, and/or one or more DUs. A network node 310 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 310 may be interconnected to one another or to one or more other network nodes 310 in the wireless network 300 through various types of fronthaul, midhaul, and/or backhaul interfaces, such as a direct physical connection, an air interface, or a virtual network, using any suitable transport network.

In some examples, a network node 310 may provide communication coverage for a particular geographic area. In the Third Generation Partnership Project (3GPP), the term “cell” can refer to a coverage area of a network node 310 and/or a network node subsystem serving this coverage area, depending on the context in which the term is used. A network node 310 may provide communication coverage for a macro cell, a pico cell, a femto cell, and/or another type of cell. A macro cell may cover a relatively large geographic area (e.g., several kilometers in radius) and may allow unrestricted access by UEs 320 with service subscriptions. A pico cell may cover a relatively small geographic area and may allow unrestricted access by UEs 320 with service subscriptions. A femto cell may cover a relatively small geographic area (e.g., a home) and may allow restricted access by UEs 320 having association with the femto cell (e.g., UEs 320 in a closed subscriber group (CSG)). A network node 310 for a macro cell may be referred to as a macro network node. A network node 310 for a pico cell may be referred to as a pico network node. A network node 310 for a femto cell may be referred to as a femto network node or an in-home network node. In the example shown in FIG. 3, the network node 310a may be a macro network node for a macro cell 302a, the network node 310b may be a pico network node for a pico cell 302b, and the network node 310c may be a femto network node for a femto cell 302c. A network node may support one or multiple (e.g., three) cells. In some examples, a cell may not necessarily be stationary, and the geographic area of the cell may move according to the location of a network node 310 that is mobile (e.g., a mobile network node).

In some aspects, the term “base station” or “network node” may refer to an aggregated base station, a disaggregated base station, an IAB node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 310. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 300 may include one or more relay stations. A relay station is a network node that can receive a transmission of data from an upstream node (e.g., a network node 310 or a UE 320) and send a transmission of the data to a downstream node (e.g., a UE 320 or a network node 310). A relay station may be a UE 320 that can relay transmissions for other UEs 320. In the example shown in FIG. 3, the network node 310d (e.g., a relay network node) may communicate with the network node 310a (e.g., a macro network node) and the UE 320d in order to facilitate communication between the network node 310a and the UE 320d. A network node 310 that relays communications may be referred to as a relay station, a relay base station, a relay network node, a relay node, a relay, or the like.

The wireless network 300 may be a heterogeneous network that includes network nodes 310 of different types, such as macro network nodes, pico network nodes, femto network nodes, relay network nodes, or the like. These different types of network nodes 310 may have different transmit power levels, different coverage areas, and/or different impacts on interference in the wireless network 300. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 330 may couple to or communicate with a set of network nodes 310 and may provide coordination and control for these network nodes 310. The network controller 330 may communicate with the network nodes 310 via a backhaul communication link or a midhaul communication link. The network nodes 310 may communicate with one another directly or indirectly via a wireless or wireline backhaul communication link. In some aspects, the network controller 330 may be a CU or a core network device, or may include a CU or a core network device.

For example, in some aspects, the wireless network 300 may be, include, or be included in a wireless backhaul network, sometimes referred to as an IAB network. In an IAB network, at least one network node (e.g., network node 310) may be an anchor base station that communicates with a core network via a wired backhaul link, such as a fiber connection. An anchor base station may also be referred to as an IAB donor (or IAB-donor), a central entity, a central unit, and/or the like. An IAB network may include one or more non-anchor base stations, sometimes referred to as relay base stations or IAB nodes (or IAB-nodes). The non-anchor base station may communicate directly with or indirectly with (e.g., via one or more non-anchor base stations) the anchor base station via one or more backhaul links to form a backhaul path to the core network for carrying backhaul traffic. Backhaul links may be wireless links. Anchor base station(s) and/or non-anchor base station(s) may communicate with one or more UEs (e.g., UE 320) via access links, which may be wireless links for carrying access traffic.

In some aspects, a radio access network that includes an IAB network may utilize millimeter wave technology and/or directional communications (e.g., beamforming, precoding and/or the like) for communications between base stations and/or UEs (e.g., between two base stations, between two UEs, and/or between a base station and a UE). For example, wireless backhaul links between base stations may use millimeter waves to carry information and/or may be directed toward a target base station using beamforming, precoding, and/or the like. Similarly, wireless access links between a UE and a base station may use millimeter waves and/or may be directed toward a target wireless node (e.g., a UE and/or a base station). In this way, inter-link interference may be reduced.

An IAB network may include an IAB donor that connects to a core network via a wired connection (e.g., a wireline backhaul). For example, an Ng interface of an IAB donor may terminate at a core network. Additionally, or alternatively, an IAB donor may connect to one or more devices of the core network that provide a core access and mobility management function (AMF). In some aspects, an IAB donor may include a base station 310, such as an anchor base station. An IAB donor may include a CU, which may perform access node controller (ANC) functions and/or AMF functions. The CU may configure a DU of the IAB donor and/or may configure one or more IAB nodes (e.g., a mobile termination (MT) function and/or a DU function of an IAB node) that connect to the core network via the IAB donor. Thus, a CU of an IAB donor may control and/or configure the entire IAB network (or a portion thereof) that connects to the core network via the IAB donor, such as by using control messages and/or configuration messages (e.g., a radio resource control (RRC) configuration message or an F1 application protocol (F1AP) message).

The MT functions of an IAB node (e.g., a child node) may be controlled and/or scheduled by another IAB node (e.g., a parent node of the child node) and/or by an IAB donor. The DU functions of an IAB node (e.g., a parent node) may control and/or schedule other IAB nodes (e.g., child nodes of the parent node) and/or UEs 320. Thus, a DU may be referred to as a scheduling node or a scheduling component, and an MT may be referred to as a scheduled node or a scheduled component. In some aspects, an IAB donor may include DU functions and not MT functions. That is, an IAB donor may configure, control, and/or schedule communications of IAB nodes and/or UEs 320. A UE 320 may include only MT functions, and not DU functions. That is, communications of a UE 320 may be controlled and/or scheduled by an IAB donor and/or an IAB node (e.g., a parent node of the UE 320).

When a first node controls and/or schedules communications for a second node (e.g., when the first node provides DU functions for the second node's MT functions), the first node may be referred to as a parent node of the second node, and the second node may be referred to as a child node of the first node. A child node of the second node may be referred to as a grandchild node of the first node. Thus, a DU function of a parent node may control and/or schedule communications for child nodes of the parent node. A parent node may be an IAB donor or an IAB node, and a child node may be an IAB node or a UE 320. Communications of an MT function of a child node may be controlled and/or scheduled by a parent node of the child node.

A link between a UE 320 and an IAB donor, or between a UE 320 and an IAB node, may be referred to as an access link. An access link may be a wireless access link that provides a UE 320 with radio access to a core network via an IAB donor, and optionally via one or more IAB nodes. Thus, the wireless network 300 may be referred to as a multi-hop network or a wireless multi-hop network.

A link between an IAB donor and an IAB node or between two IAB nodes may be referred to as a backhaul link. A backhaul link may be a wireless backhaul link that provides an IAB node with radio access to a core network via an IAB donor, and optionally via one or more other IAB nodes. In an IAB network, network resources for wireless communications (e.g., time resources, frequency resources, and/or spatial resources) may be shared between access links and backhaul links. In some aspects, a backhaul link may be a primary backhaul link or a secondary backhaul link (e.g., a backup backhaul link). In some aspects, a secondary backhaul link may be used if a primary backhaul link fails, becomes congested, and/or becomes overloaded, among other examples.

The UEs 320 may be dispersed throughout the wireless network 300, and each UE 320 may be stationary or mobile. A UE 320 may include, for example, an access terminal, a terminal, a mobile station, and/or a subscriber unit. A UE 320 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 320 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 320 may be considered Internet-of-Things (IoT) devices, and/or may be implemented as NB-IoT (narrowband IoT) devices. Some UEs 320 may be considered a Customer Premises Equipment. A UE 320 may be included inside a housing that houses components of the UE 320, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 300 may be deployed in a given geographic area. Each wireless network 300 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 320 (e.g., shown as UE 320a and UE 320e) may communicate directly using one or more sidelink channels (e.g., without using a network node 310 as an intermediary to communicate with one another). For example, the UEs 320 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 320 may perform scheduling operations, resource selection operations, and/or other operations described elsewhere herein as being performed by the network node 310.

Devices of the wireless network 300 may communicate using the electromagnetic spectrum, which may be subdivided by frequency or wavelength into various classes, bands, channels, or the like. For example, devices of the wireless network 300 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described above, in some aspects, a network node (e.g., the network node 102A, 102B, and/or 102C depicted in FIG. 1) may be implemented in a wireless communication environment. For example, in some aspects, the network node may be implemented as a UE, a base station, relay device, and/or TRP, among other examples. In some such aspects, as shown in FIG. 3, the UE 320a may include a communication manager 340 and/or a transceiver 345 and the network node 310a may include a communication manager 350 and/or a transceiver 355. In some aspects, the communication manager 340 and/or 350 may be, be similar to, include, or be included in, the communication manager 106 depicted in FIG. 1 and/or the communication manager 235 depicted in FIG. 2. In some aspects, the transceiver 345 and/or 355 may be, be similar to, include, or be included in, the transceiver 108 depicted in FIG. 1. In some aspects, the transceiver 345 and/or 355 may include, or be included in, the communication interface 230 depicted in FIG. 2.

In some aspects, a first network node (e.g., a network node 310) may include a communication manager 350. As described in more detail elsewhere herein, the communication manager 350 may obtain a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment; provide, to a second network node, a data channel service request that indicates the data channel application identifier; obtain, from the second network node, a service response comprising a data channel control policy associated with the data channel application identifier; and allocate, based at least in part on the data channel control policy, media resources corresponding to at least one application data channel and associated with the first user equipment and the second user equipment.

In some aspects, the communication manager 350 may obtain, from a second network node, a data channel application identifier corresponding to a data channel application associated with a multimedia call session between a first user equipment and a second user equipment; and provide, to the first user equipment, the data channel application identifier based on the first user equipment obtaining a first instance of the data channel application. Additionally, or alternatively, the communication manager 350 may perform one or more other operations described herein.

In some aspects, a UE (e.g., a UE 320) may include a communication manager 340. As described in more detail elsewhere herein, the communication manager 340 may provide, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment; and obtain, from the first network node, an allocation of media resources corresponding to at least one application data channel and associated with the first user equipment and the second user equipment, wherein the allocation is based on a data channel control policy associated with the data channel application identifier. Additionally, or alternatively, the communication manager 340 may perform one or more other operations described herein.

In some aspects, the communication manager 340 may obtain, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment; communicate data channel traffic via at least one application data channel between the first user equipment and the second user equipment; and associate the data channel traffic with the data channel application identifier. Additionally, or alternatively, the communication manager 340 may perform one or more other operations described herein.

As indicated above, FIG. 3 is provided as an example. Other examples may differ from what is described with regard to FIG. 3.

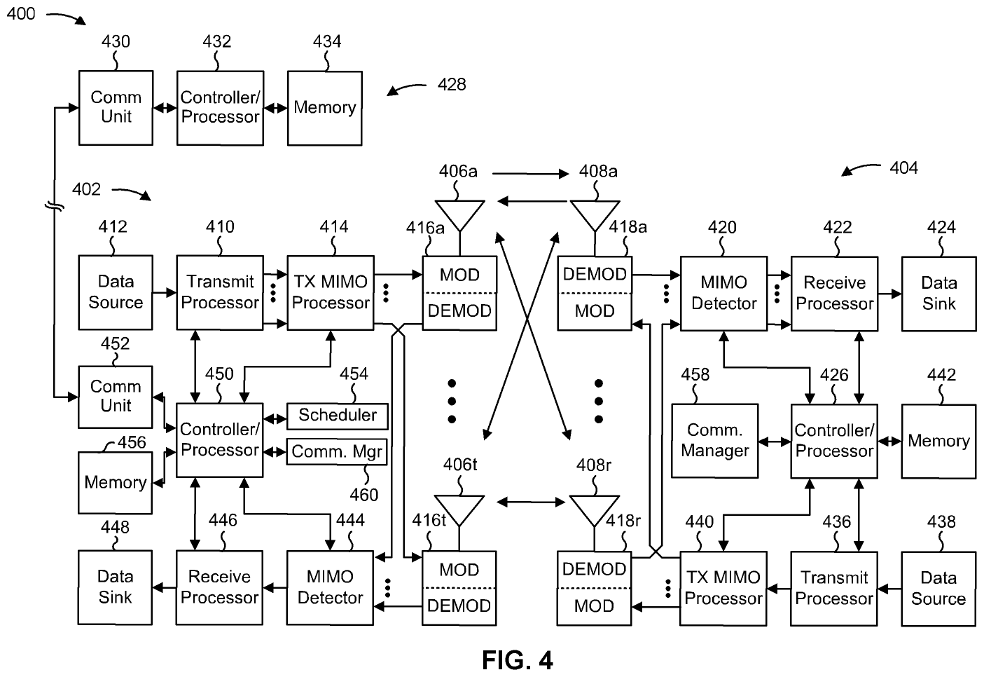

FIG. 4 is a diagram illustrating an environment 400 including a network node 402 in wireless communication with a network node 404 (e.g., via a network such as the network 104 depicted in FIG. 1 and/or the wireless network 300 depicted in FIG. 3), in accordance with the present disclosure. The network node 402 may be equipped with a set of antennas 406a through 406t, such as T antennas (T≥1). The network node 404 may be equipped with a set of antennas 408a through 408r, such as R antennas (R≥1).

At the network node 402, a transmit processor 410 may receive data, from a data source 412, intended for the network node 404 (or a set of network nodes 404). The transmit processor 410 may select one or more modulation and coding schemes (MCSs) for the network node 404 based on one or more channel quality indicators (CQIs) received from that network node 404. The network node 402 may process (e.g., encode and modulate) the data for the network node 404 based on the MCS(s) selected for the network node 404 and may provide data symbols for the network node 404. The transmit processor 410 may process system information (e.g., for semi-static resource partitioning information (SRPI)) and control information (e.g., CQI requests, grants, and/or upper layer signaling) and provide overhead symbols and control symbols. The transmit processor 410 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 414 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 416a through 416t (e.g., T modems). For example, each output symbol stream may be provided to a modulator component (shown as MOD) of a modem of the set of modems 416a through 416t. Each modem of the set of modems 416a through 416t may use a respective modulator component to process a respective output symbol stream (e.g., for OFDM) to obtain an output sample stream. Each modem of the set of modems 416a through 416t may further use a respective modulator component to process (e.g., convert to analog, amplify, filter, and/or upconvert) the output sample stream to obtain a signal. One or more modems of the set of modems 416a through 416t may transmit a set of signals (e.g., 7 signals) via a corresponding antenna of the set of antennas 406a through 406t. The signal may include, for example, a downlink signal.

At the network node 404, one or more antennas of the set of antennas 408a through 408r may receive the signals from the network node 402 and/or network nodes and may provide a set of received signals (e.g., R received signals) to one or more modems of a set of modems 418a through 418r (e.g., R modems). For example, each received signal may be provided to a demodulator component (shown as DEMOD) of a respective modem of the set of modems 418a through 418r. Each modem of the set of modems 418a through 418r may use a respective demodulator component to condition (e.g., filter, amplify, downconvert, and/or digitize) a received signal to obtain input samples. Each modem of the set of modems 418a through 418r may use a demodulator component to further process the input samples (e.g., for OFDM) to obtain received symbols. A MIMO detector 420 may obtain received symbols from one or more modems of the set of modems 418a through 418r, may perform MIMO detection on the received symbols if applicable, and may provide detected symbols.

A receive processor 422 may process (e.g., demodulate and decode) the detected symbols, may provide decoded data for the network node 404 to a data sink 424, and may provide decoded control information and system information to a controller/processor 426. The term “controller/processor” may refer to one or more controllers, one or more processors, or a combination thereof. The controller/processor 426 may be, be similar to, include, or be included in, the processor 210 depicted in FIG. 2. The controller/processor 426 may determine a reference signal received power (RSRP) parameter, a received signal strength indicator (RSSI) parameter, a reference signal received quality (RSRQ) parameter, and/or a CQI parameter, among other examples.

A network controller 428 may include a communication unit 430, a controller/processor 432, and a memory 434. The network controller 428 may be, be similar to, include, or be included in, the network controller 330 depicted in FIG. 3. The network controller 428 may include, for example, one or more devices in a core network. The network controller 428 may communicate with the network node 402 via the communication unit 430.

One or more antennas (e.g., antennas 406a through 406t and/or antennas 408a through 408r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 4.

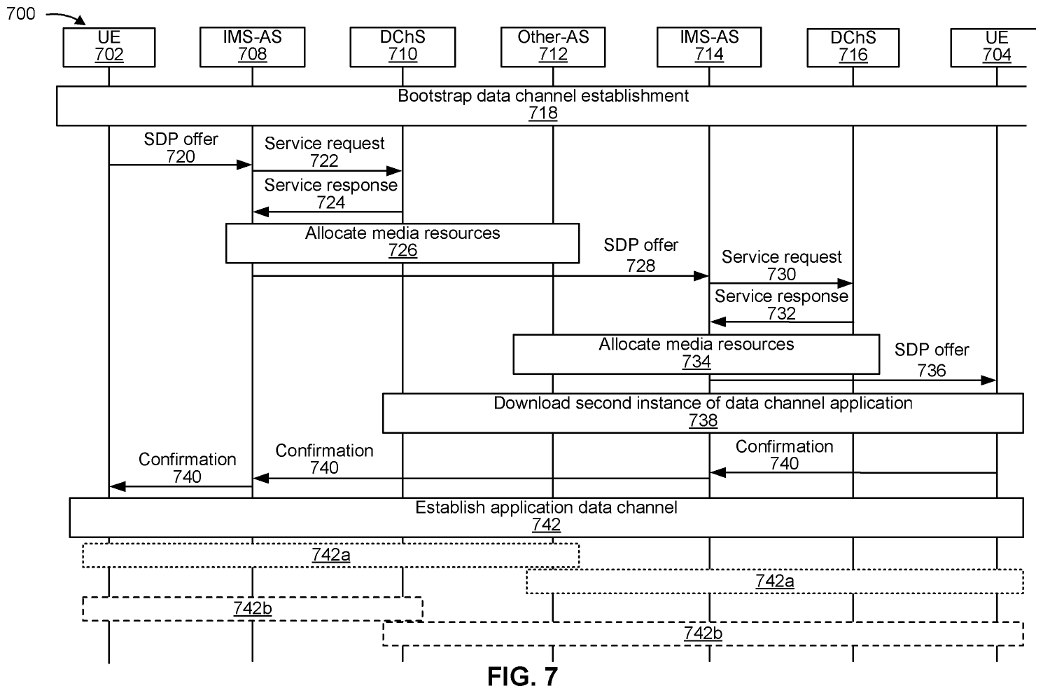

Similarly, at the network node 404, a transmit processor 436 may receive and process data from a data source 438 and control information (e.g., for reports that include RSRP, RSSI, RSRQ, and/or CQI) from the controller/processor 426. The transmit processor 436 may generate reference symbols for one or more reference signals. The symbols from the transmit processor 436 may be precoded by a TX MIMO processor 440 if applicable, and further processed by one or more of the set of modems 418a through 418r (e.g., for DFT-s-OFDM or CP-OFDM), and transmitted to the network node 402. In some examples, each modem of the set of modems 418a through 418r of the network node 404 may include a modulator and a demodulator. In some examples, the network node 404 includes a transceiver. The transceiver may include any combination of the antenna(s) 408a through 408r, the modem(s) 418a through 418r, the MIMO detector 420, the receive processor 422, the transmit processor 436, and/or the TX MIMO processor 440. The transceiver may be, be similar to, include, or be included in, the transceiver 108 depicted in FIG. 1 and/or the communication interface 230 depicted in FIG. 2. The transceiver may be used by a processor (e.g., the controller/processor 426) and/or a memory 442 to perform aspects of any of the methods described herein (e.g., with reference to FIGS. 7-13).

At the network node 402, the signals from network node 404 and/or other network nodes may be received by one or more antennas of the set of antennas 406a through 406t, processed by one or more modems of the set of modems 416a through 416t (e.g., a demodulator component, shown as DEMOD), detected by a MIMO detector 444 if applicable, and further processed by a receive processor 446 to obtain decoded data and control information sent by the network node 404. The receive processor 446 may provide the decoded data to a data sink 448 and provide the decoded control information to a controller/processor 450. The network node 402 may include a communication unit 452 and may communicate with the network controller 428 via the communication unit 452. The network node 402 may include a scheduler 454 to schedule one or more network nodes 404 for downlink and/or uplink communications. In some examples, one or more modems of the set of modem 416a through 416t of the network node 402 may include a modulator and a demodulator. In some examples, the network node 402 includes a transceiver. The transceiver may include any combination of the antenna(s) 406a through 406t, the modem(s) 416a through 416t, the MIMO detector 444, the receive processor 446, the transmit processor 410, and/or the TX MIMO processor 414. The transceiver may be, be similar to, include, or be included in, the transceiver 108 depicted in FIG. 1 and/or the communication interface 230 depicted in FIG. 2. The transceiver may be used by a processor (e.g., the controller/processor 450) and a memory 456 to perform aspects of any of the methods described herein (e.g., with reference to FIGS. 7-13).

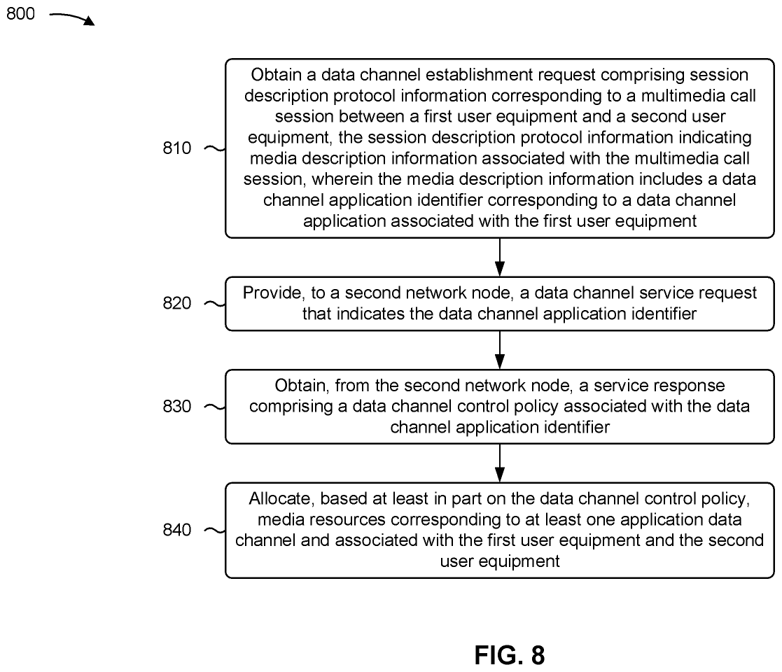

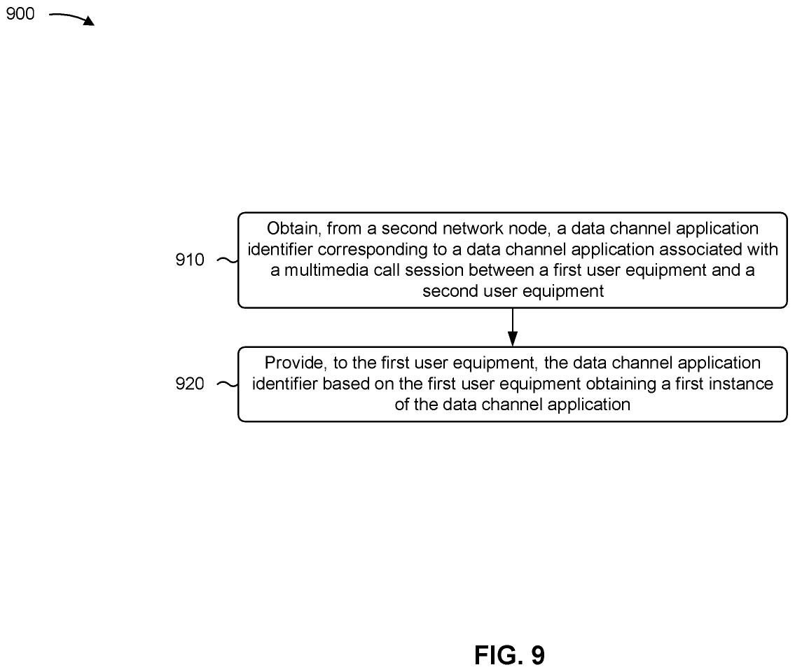

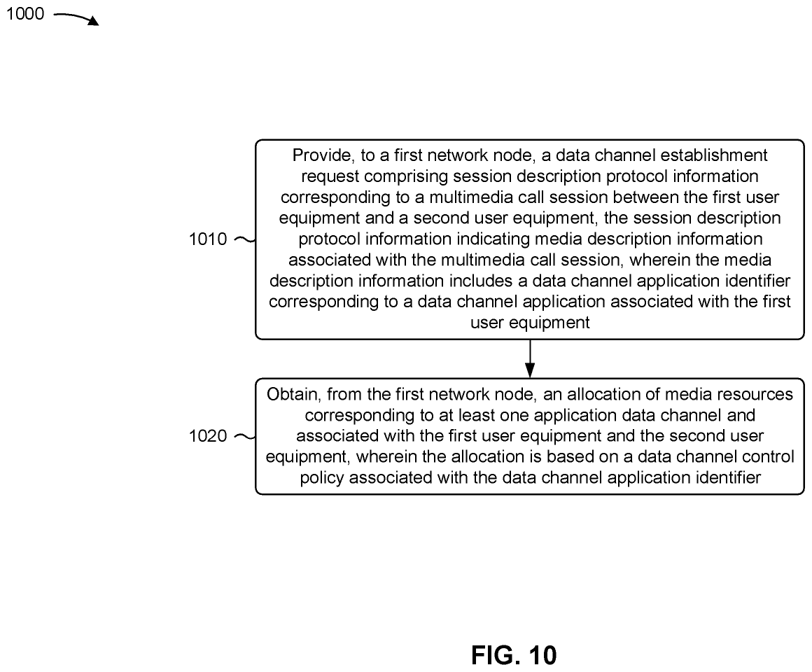

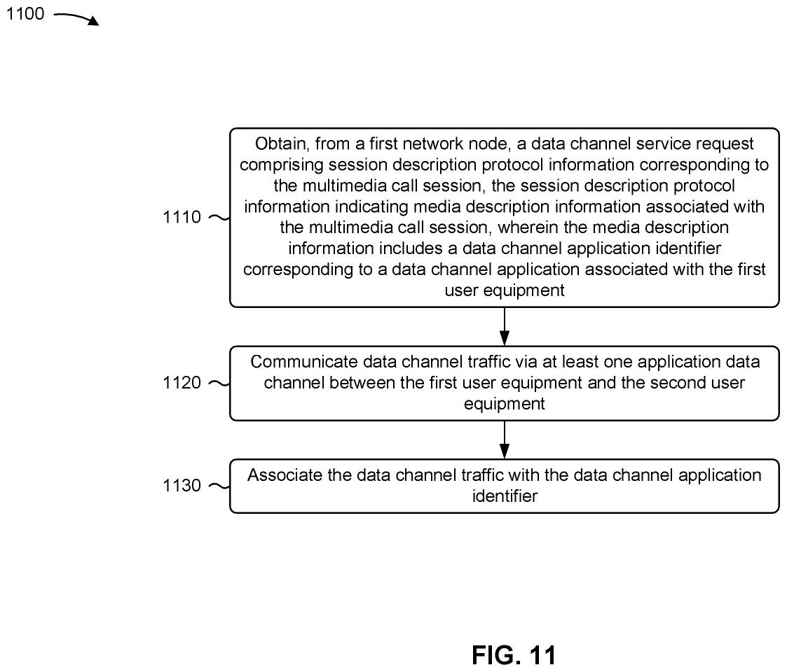

The controller/processor 450 of the network node 402, the controller/processor 426 of the network node 404, and/or any other component(s) of FIG. 4 may perform one or more techniques associated with data channel communications associated with an IMS, as described in more detail elsewhere herein. For example, the controller/processor 450 of the network node 402, the controller/processor 426 of the network node 404, and/or any other component(s) of FIG. 4 may perform or direct operations of, for example, process 800 of FIG. 8, process 900 of FIG. 9, process 1000 of FIG. 10, process 1100 of FIG. 11, and/or other processes as described herein. The memory 442 and the memory 456 may store data and program codes for the network node 402 and the network node 404, respectively. In some examples, the memory 442 and/or the memory 456 may include a non-transitory computer-readable medium storing one or more instructions (e.g., code and/or program code) for wireless communication. For example, the one or more instructions, when executed (e.g., directly, or after compiling, converting, and/or interpreting) by one or more respective processors of the network node 402 and/or the network node 404, may cause the one or more processors, the network node 404, and/or the network node 402 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the first network node 402 includes means for obtaining a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment; means for providing, to a second network node, a data channel service request that indicates the data channel application identifier; means for obtaining, from the second network node, a service response comprising a data channel control policy associated with the data channel application identifier; and/or means for allocating, based at least in part on the data channel control policy, media resources corresponding to at least one application data channel and associated with the first user equipment and the second user equipment.

In some aspects, the first network node 402 includes means for obtaining, from a second network node, a data channel application identifier corresponding to a data channel application associated with a multimedia call session between a first user equipment and a second user equipment; and/or means for providing, to the first user equipment, the data channel application identifier based on the first user equipment obtaining a first instance of the data channel application. In some aspects, the means for the first network node to perform operations described herein may include, for example, one or more of communication manager 460, transmit processor 410, TX MIMO processor 414, modem 416, antenna 406, MIMO detector 444, receive processor 446, controller/processor 450, memory 456, or scheduler 454.

In some aspects, a UE 404 includes means for providing, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment; and/or means for obtaining, from the first network node, an allocation of media resources corresponding to at least one application data channel and associated with the first user equipment and the second user equipment, wherein the allocation is based on a data channel control policy associated with the data channel application identifier.

In some aspects, the UE 404 includes means for obtaining, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment; means for communicating data channel traffic via at least one application data channel between the first user equipment and the second user equipment; and/or means for associating the data channel traffic with the data channel application identifier. The means for the second user equipment to perform operations described herein may include, for example, one or more of communication manager 458, antenna 408, modem 418, MIMO detector 420, receive processor 422, transmit processor 436, TX MIMO processor 440, controller/processor 426, or memory 442.

While blocks in FIG. 4 are illustrated as distinct components, the functions described above with respect to the blocks may be implemented in a single hardware, software, or combination component or in various combinations of components. For example, the functions described with respect to the transmit processor 436, the receive processor 422, and/or the TX MIMO processor 440 may be performed by or under the control of the controller/processor 426. Any number of other combination of various combinations of components depicted in FIG. 4 may be considered to be within the ambit of the present disclosure.

As indicated above, FIG. 4 is provided as an example. Other examples may differ from what is described with regard to FIG. 4.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

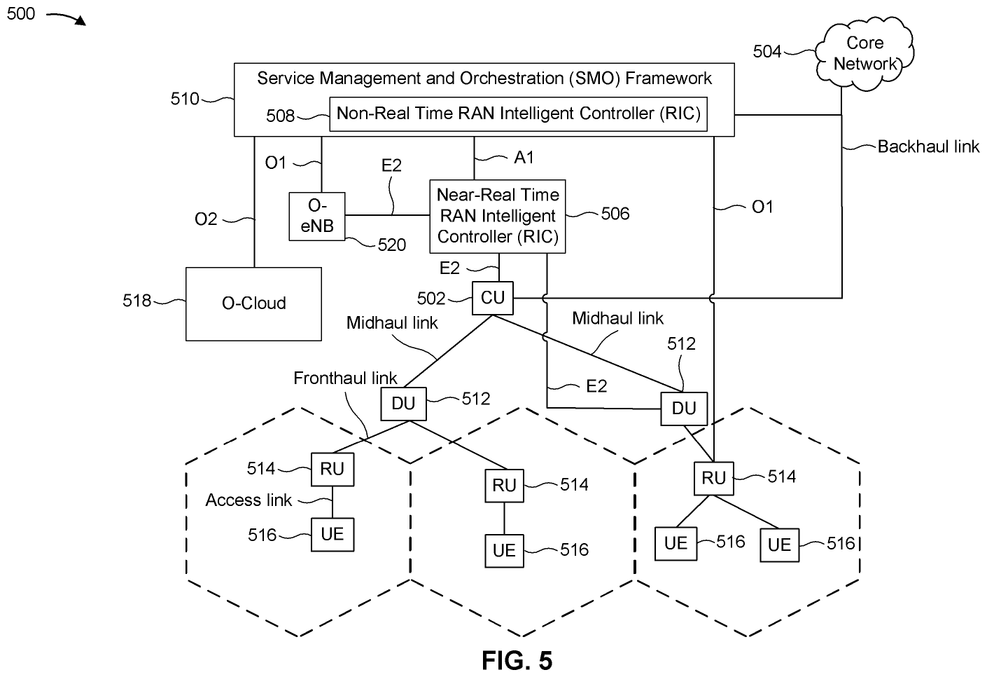

FIG. 5 is a diagram illustrating an example disaggregated base station architecture 500, in accordance with the present disclosure. The disaggregated base station architecture 500 may include a CU 502 that can communicate directly with a core network 504 via a backhaul link, or indirectly with the core network 504 through one or more disaggregated control units (such as a Near-RT RIC 506 via an E2 link, or a Non-RT RIC 508 associated with a Service Management and Orchestration (SMO) Framework 510, or both). A CU 502 may communicate with one or more DUs 512 via respective midhaul links, such as through F1 interfaces. Each of the DUs 512 may communicate with one or more RUs 514 via respective fronthaul links. Each of the RUs 514 may communicate with one or more UEs 516 via respective RF access links. In some implementations, a UE 516 may be simultaneously served by multiple RUs 514.

Each of the units, including the CU 502, the DUs 512, the RUs 514, as well as the Near-RT RICs 506, the Non-RT RICs 508, and the SMO Framework 510, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 502 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 502. The CU 502 may be configured to handle user plane functionality (for example, Central Unit—User Plane (CU-UP) functionality), control plane functionality (for example,

Central Unit—Control Plane (CU-CP) functionality), or a combination thereof. In some implementations, the CU 502 can be logically split into one or more CU-UP units and one or more CU-CP units. A CU-UP unit can communicate bidirectionally with a CU-CP unit via an interface, such as the El interface when implemented in an O-RAN configuration. The CU 502 can be implemented to communicate with a DU 512, as necessary, for network control and signaling.

Each DU 512 may correspond to a logical unit that includes one or more base station functions to control the operation of one or more RUs 514. In some aspects, the DU 512 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 512 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 512, or with the control functions hosted by the CU 502.

Each RU 514 may implement lower-layer functionality. In some deployments, an RU 514, controlled by a DU 512, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 514 can be operated to handle over the air (OTA) communication with one or more UEs 516. In some implementations, real-time and non-real-time aspects of control and user plane communication with the RU(s) 514 can be controlled by the corresponding DU 512. In some scenarios, this configuration can enable each DU 512 and the CU 502 to be implemented in a cloud-based RAN architecture, such as a vRAN architecture.

The SMO Framework 510 may be configured to support RAN deployment and provisioning of non-virtualized and virtualized network elements. For non-virtualized network elements, the SMO Framework 510 may be configured to support the deployment of dedicated physical resources for RAN coverage requirements, which may be managed via an operations and maintenance interface (such as an O1 interface). For virtualized network elements, the SMO Framework 510 may be configured to interact with a cloud computing platform (such as an open cloud (O-Cloud) platform 518) to perform network element life cycle management (such as to instantiate virtualized network elements) via a cloud computing platform interface (such as an O2 interface). Such virtualized network elements can include, but are not limited to, CUs 502, DUs 512, RUs 514, Near-RT RICs 506, and non-RT RICs 508. In some implementations, the SMO Framework 510 can communicate with a hardware aspect of a 4G RAN, such as an open eNB (O-eNB) 520, via an O1 interface. Additionally, in some implementations, the SMO Framework 510 can communicate directly with each of one or more RUs 514 via a respective O1 interface. The SMO Framework 510 also may include a Non-RT RIC 508 configured to support functionality of the SMO Framework 510.

The Non-RT RIC 508 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 506. The Non-RT RIC 508 may be coupled to or communicate with (such as via an A1 interface) the Near-RT RIC 506. The Near-RT RIC 506 may be configured to include a logical function that enables near-real-time control and optimization of RAN elements and resources via data collection and actions over an interface (such as via an E2 interface) connecting one or more CUs 502, one or more DUs 512, or both, as well as an O-eNB 520, with the Near-RT RIC 506.

In some implementations, to generate AI/ML models to be deployed in the Near-RT RIC 506, the Non-RT RIC 508 may receive parameters or external enrichment information from external servers. Such information may be utilized by the Near-RT RIC 506 and may be received at the SMO Framework 510 or the Non-RT RIC 508 from non-network data sources or from network functions. In some examples, the Non-RT RIC 508 or the Near-RT RIC 506 may be configured to tune RAN behavior or performance. For example, the Non-RT RIC 508 may monitor long-term trends and patterns for performance and employ AI/ML models to perform corrective actions through the SMO Framework 510 (such as reconfiguration via an O1 interface) or via creation of RAN management policies (such as A1 interface policies).

As indicated above, FIG. 5 is provided as an example. Other examples may differ from what is described with regard to FIG. 5.

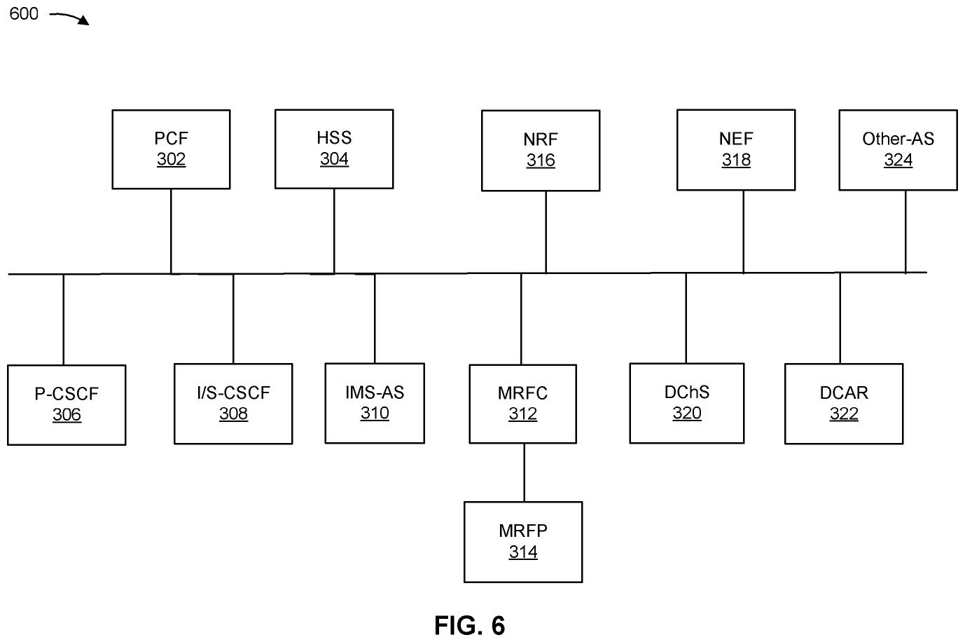

FIG. 6 is a diagram illustrating an example 600 of a service-based architecture for providing a data channel associated with an IMS, in accordance with the present disclosure. As shown in FIG. 6, example 600 includes a policy control function (PCF) 602, a home subscriber service (HSS) 604, a proxy-call session control function (P-CSCF) 606, an interrogating/serving (I/S)-CSCF 608, an IMS-application server (IMS-AS) 610, a media resource function controller (MRFC) 612, and a media resource function processor (MRFP) 614. The example 600 also includes a network repository function (NRF) 616, a network exposure function (NEF) 618, a data channel server (DChS) 620, a data channel application repository (DCAR) 622, and an other application server (other-AS) 624. In some aspects, the NEF 616 and the NEF 618 may be 5G core network functions that include a data channel interface to the IMS of example 600.

The PCF 602 may facilitate access to a wireless telecommunications network by the IMS and may manage network policy compliance associated with the interface between the wireless telecommunications network and the IMS. The HSS 604 may maintain and manage an IMS user profile associated with a UE (e.g., the UE 102 and/or 104). The P-CSCF 606 is a session initiation protocol (SIP) proxy that may provide an interface between the IMS and a UE (e.g., the UE 102 and/or 104). The P-CSCF provides subscriber authentication and may establish security protocols with respect to the IMS. The I/S-CSCF 608 may include an interrogation function that queries the HSS 604 to obtain an address for a serving CSCF function of the I/S-CSCF 608 and may assign the address to a UE registering with the IMS. The serving CSCF function of the I/S-CSCF 608 is a SIP server and also may perform session control. The serving CSCF function of the I/S-CSCF 608 may facilitate managing SIP registrations, provide routing and enforce IMS and/or network policies.

The IMS-AS 610 hosts and executes IMS services. The IMS-AS 610 may interface with the I/S-CSCF 608 using SIP. The MRFC 612 and the MRFP 614 form a media resource function (MRF) that provides media functions such as media manipulation, video and audio mixing, and/or other application-based media services. The MRFC 612 is a signaling plane IMS node that may interpret information received from the IMS-AS 610 and/or the I/S-CSCF 608 to control the MRFP 614. The MRFC 612 may include a service-based interface to support the handling of media data from data channels and convergence of the media data with audio and/or video traffic in the media channels. The MRFP 614 is a media plane IMS node that may be used to source, combine, and/or otherwise process media streams.

The NRF 616 and the NEF 618 may be network functions that include communication interfaces that enable the NRF 616 and the NEF 618 to communicate using a data channel, as described herein. In some aspects, the MRFC 612 also may include a communication interface that enables the MRFC 612 to communicate using the data channel. The NRF 616 may maintain a list of available network functions instances and associated profiles. The NRF 616 also may support a service discovery function associated with the IMS. In some aspects, the NEF 618 may expose services and resources inside and outside of the wireless telecommunications network core. The NEF 618 may support provision of external information to the IMS. In some aspects, for example, the NEF 618 may support provision of data channel applications to the IMS network.

The DChS 620 may receive data channel applications from UEs and/or other otherized entities and may store the data channel applications in the DCAR 622. The DChS 620 may manage data channels with data-channel-capable multimedia telephony service for IMS (DCMTSI) clients according to requests from the IMS-AS 610. For example, in some aspects, the UE 102 and the UE 104 may include DCMTSI clients. The DChS 620 may distribute data channel applications and/or data channel application updates to DCMTSI clients (e.g., the UE 102 and/or 104) and may route data channel application traffic between the DCMTSI clients and application servers. In some aspects, the DChS 620 may generate data channel traffic usage reports and data channel event reports to facilitate management of the data channel. The DCAR 622 is a repository that may store and retrieve data channel applications.

The Other-AS 624 may include one or more other application servers configured to provide media services associated with a data channel application. For example, in some aspects, the Other-AS 624 may include an extended reality (XR) Application Server and/or a third party web real-time communication (WebRTC) server, among other examples. XR application servers may include augmented reality (AR) application servers, virtual reality (VR) application servers, and/or mixed reality (MR) application servers, among other examples. By integrating a data channel application ID with data channel related functions and SDP information associated with one or more of an IMS-AS 610, a DChS 620, and an other-AS 624 in the IMS architecture, some aspects may facilitate data channel application use within an IMS, as described in further detail below with respect to FIG. 7.

For example, in some cases, after bootstrap data channels are established for an IMS session, DCMTSI UEs may download data channel applications from the DChS 620 and trigger the establishment of data channels for selected applications. The DChS 620 may determine the anchor point and route traffic associated with a data channel application. There can be two types of establishing procedures for establishing an application data channel. According to a first type, an application data channel can be established between UEs. According to a second type, an application data channel can be established between a UE and the network. In some cases, the DChS 620 can be unaware of which data channel application is going to be associated with traffic in the data channel. Without awareness of the serving data channel applications, it can be difficult for the DChS 620 to determine the proper data channel control policy for a specific data channel. The data channel control policy may provide procedures for traffic flow, requirements for anchoring data channels in the DChS 620, requirements for routing traffic to the Other-AS(s) 624 and/or procedures for selection of the Other-AS(s) 624, among other examples.

Some aspects of the techniques and apparatuses described herein may facilitate identification of appropriate data channel control policies based on a data channel application ID. For example, in some aspects, a UE may send, to an IMS-AS, a data channel establishment request (e.g., an SDP offer for the establishment of an application data channel) that includes a data channel application ID. The data channel application ID may be included in a service request from the IMS-AS to a DChS. Upon receiving the data channel application ID, the DChS may check the corresponding data channel application profile and determine the data channel control policy for the associated data channel. If the data channel application ID is not available in the SDP Offer, the DChS may determine the data channel control policy based on a mobile network operator's policy (e.g., direct data channel connection between UEs).

In some cases, data transmission on data channels may not start until each UE involved in a multimedia call session has confirmed that it has downloaded the appropriate data channel application or applications and instantiated the corresponding data channel or data channels. After the establishment of a bootstrap data channel, a first UE may select to download the selected data channel application via the bootstrap data channel and initiate the corresponding data channel via an SDP offer. However, a second UE that is to participate on the call may be unaware of the data channel application downloaded by the first UE. One possible solution could be to notify the second UE via the bootstrap data channel. However, the bootstrap data channel may not be intended for use directly between DCMTSI clients in terminal. DCMTSI clients in terminal that receive hypertext transfer protocol (HTTP) requests on a bootstrap data channel can be configured to ignore such requests and may even update the session by removing the SDP “a=dcmap” line with the stream ID where the HTTP request was received and close that stream ID. A DCMTSI client in terminal that retrieves a data channel application from a stream ID different than 0 or 10 (e.g. a data channel application from the peer), may be configured to not initiate any subsequent offer to open data channels used by that data channel application. Thus, a first UE may be unable to trigger a second UE via an HTTP request in the bootstrap data channel for downloading of the selected data channel application by the second UE.

Some aspects of the techniques and apparatuses described herein may facilitate informing one UE of a data channel application downloaded by another UE so that both UEs may use instances of the same data channel application in a multimedia call session. For example, in some aspects, a first UE may download a first instance of a data channel application and may provide a data channel application ID associated with the data channel application to a second UE via a data channel establishment request (e.g., an SDP offer). Upon receiving the data channel application ID, the second UE (e.g., based on user input) may accept or reject the SDP offer according to the data channel application ID (and/or associated information such as a data channel application name). If the SDP offer is accepted, the second UE may determine an availability of the data channel application and may trigger the downloading of a second instance of the data channel application before sending an SDP answer. If the data channel application ID is not included in the SDP offer, the IMS may implicitly determine that the second UE has already instantiated the data channel application (e.g., the data channel application may be pre-configured in the second UE and/or the second UE may have downloaded all of the feasible data channel applications from the DChS(s)).

To facilitate some aspects described herein, some enhancements to network entities may be performed. For example, in some aspects, a DChS may be enhanced to support retrieving or allocating a data channel application ID when a data channel application is provided and uploaded to the data channel application repository, retrieving and storing a data channel application profile in the DChS, delivering the associated data channel application IDs when a UE downloads data channel applications, and/or determining a data channel control policy based on a data channel application ID, among other examples. In some aspects, a UE may be enhanced to support adding a data channel application ID in an SDP offer when initiating SDP negotiation for a data channel, triggering the downloading of an instance of an identified data channel application via a bootstrap data channel, and/or associating data channel traffic with the identified data channel application (e.g., via the data channel application ID), among other examples.

As indicated above, FIG. 6 is provided as an example. Other examples may differ from what is described with respect to FIG. 6.

FIG. 7 is a diagram illustrating an example 700 associated with data channel communications associated with an IMS, in accordance with the present disclosure. As shown in FIG. 7, example 700 includes a UE 702 that communicates with a UE 704. The UE 702 and UE 704 may communicate using a multimedia call session (e.g., a video call) via an IMS such as, for example, an IMS having one or more aspects of the IMS architecture depicted in example 600 of FIG. 6. The UE 702 and/or the UE 704 may be, be similar to, include, or be included in, the UE 512 depicted in FIG. 5, the UE 404 depicted in FIG. 4, the UE 320 depicted in FIG. 3, the apparatus depicted in FIG. 2, and/or the network node 102A and/or the network node 102B depicted in FIG. 1.

As shown, example 700 includes an IMS-AS 708, a DChS 710, an other-AS 712, an IMS-AS 714, and a DChS 716, each of which may be referred to as a “network node.” In some aspects, any number of additional network nodes may be implemented in the context of example 700 such as, for example, one or more of the IMS components depicted in FIG. 6. In some aspects, the IMS-AS 708 and/or the IMS-AS 714 may be, be similar to, include, or be included in, the IMS-AS 610 depicted in FIG. 6. The DChS 710 and/or the DChS 716 may be, be similar to, include, or be included in, the DChS 620 depicted in FIG. 6. In some aspects, the DChS 710 may be, include, or be included in, the DChS 716.

As shown by reference number 718, one or more bootstrap data channels may be established for the UE 702 and the UE 704. For example, the UE 702 (which may be referred to as the “originating UE”) may transmit, and the IMS-AS 708 may receive, an initial SDP offer for a bootstrap data channel that includes a data channel media description for one or more bootstrap data channels. A bootstrap data channel is a data channel that is established based at least in part on SDP information. The SDP information may include authentication information so that the bootstrap data channel can be used to distribute update data channel applications (and/or application updates) to a UE associated with the authentication information. In some aspects, the initial SDP offer for the data channel may be carried with an audio/video media description in an IMS session establishment communication. In some aspects, the initial SDP offer for the data channel may be carried in a separate invite request after an audio/video media channel is established successfully. The UE 702 may obtain, via the bootstrap data channel between the first UE and the IMS-AS 708, a first instance of a data channel application. The DChS 710 may provide a data channel application ID to the UE 702 with the data channel application.

As shown by reference number 720, the UE 702 may provide, and the IMS-AS 708 may obtain, a data channel establishment request (shown as “SDP offer”). The data channel establishment request may include SDP information corresponding to a multimedia call session between the UE 702 and the UE 704. The SDP information may indicate media description information associated with the multimedia call session. The media description information may include the data channel application ID corresponding to the data channel application associated with the UE 702.

As shown by reference number 722, the IMS-AS 708 may provide, and the DChS 710 may obtain, a data channel service request that indicates the data channel application ID. The data channel service request may be provided, for example, to a signaling function of the DChS 710 for the creation of a data channel. In some aspects, if the data channel application is a local application, the DChS 710 store may determine a corresponding data channel control policy (e.g. traffic route) of the data channel based on the associated data channel application profile. If the data channel creation request is intended to open a remote application from the UE 702, the DChS may reject the data channel service request.

As shown by reference number 724, the DChS 710 may provide, and the IMS-AS 708 may obtain, a service response. The service response may include the data channel control policy associated with the data channel application identifier. As shown by reference number 726, the IMS-AS 708 may allocate, based at least in part on the data channel control policy, media resources corresponding to at least one application data channel and associated with the UE 702 and the UE 704. The IMS-AS 708 may provide the resource allocation to the UE 702. In some aspects, the IMS-AS 708 also may establish one or more media connections to the other-AS 712 (and/or additional other-ASs).

As shown by reference number 728, the IMS-AS 708 may provide, and the IMS-AS 714 may obtain, the data channel establishment request (SDP offer). The IMS-AS 714 may be referred to as a terminating IMS-AS. The data channel establishment request may include the data channel application ID. As shown by reference number 730, the IMS-AS 714 may provide, and the DChS 716 may obtain, a service request indicating the data channel application ID. For example, the service request may be provided to a signaling function of the DChS 716 for creation of the data channel. As shown by reference number 732, the DChS 716 may provide, and the IMS-AS 714 may obtain, a service response that includes the data channel control policy. As shown by reference number 734, the IMS-AS 714 may allocate media resources for the data channel. The IMS-AS 714 may provide the media resource allocation to the UE 704.

As shown by reference number 736, the IMS-AS 714 may provide, and the UE 704 may obtain, a data channel service request that includes SDP information corresponding to the multimedia call session. The SDP information may indicate media description information associated with the multimedia call session. The media description information may include the data channel application ID corresponding to the data channel application associated with the UE 702.

As shown by reference number 738, the UE 704 may download a second instance of the data channel application from the DChS 710. The DChS 710 may include the data channel application ID with the second instance of the data channel application. For example, in some aspects, a user of the UE 704 may decide to accept or reject the SDP offer according to the received data channel application ID and/or other information associated with the data channel application. If the SDP offer is accepted, the UE 704 may determine whether the data channel application is instantiated at the UE 704. If not, the UE 704 may request the downloading of the second instance of the data channel application via a bootstrap data channel.

As shown by reference number 740, the UE 704 may transmit a confirmation, which may be forwarded by the IMS-AS 714 to the IMS-AS 708 and from the IMS-AS 708 to the UE 702. The confirmation may indicate that the UE 704 is ready to establish an application data channel for the multimedia call session.

As shown by reference number 742, the UE 702 and the UE 704 may establish the application data channel. For example, the IMS-AS 708 may facilitate establishment of at least one application data channel between the UE 702 and the UE 704. In some aspects, the IMS-AS 714 also may facilitate the establishment of the application data channel. As shown by reference number 742a, the at least one application data channel may include a first application data channel between the UE 702 and the other-AS 712 and a second application data channel between the other-AS 712 and the UE 704. As shown by reference number 742b, the at least one application data channel may include a first application data channel between the UE 702 and the DChS 710 (and/or the DChS 716) and a second application data channel between the DChS 710 (and/or the DChS 716) and the UE 704. The UE 702 and the UE 704 may communicate (e.g., transmit and/or receive) data channel traffic via the at least one application data channel and may associate the data channel traffic with the data channel application ID.

As indicated above, FIG. 7 is provided as an example. Other examples may differ from what is described with respect to FIG. 7.

FIG. 8 is a diagram illustrating an example process 800 performed, for example, by a first network node, in accordance with the present disclosure. Example process 800 is an example where the first network node (e.g., the IMS-AS 708) performs operations associated with data channel communications associated with an IMS.

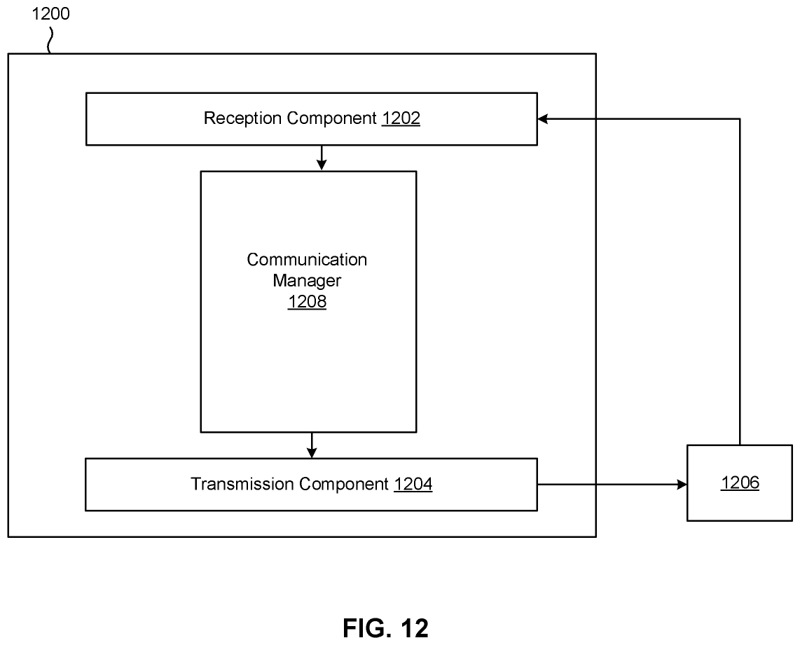

As shown in FIG. 8, in some aspects, process 800 may include obtaining a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment (block 810). For example, the first network node (e.g., using communication manager 1208 and/or reception component 1202, depicted in FIG. 12) may obtain a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment, as described above.

As further shown in FIG. 8, in some aspects, process 800 may include providing, to a second network node, a data channel service request that indicates the data channel application identifier (block 820). For example, the first network node (e.g., using communication manager 1208 and/or transmission component 1204, depicted in FIG. 12) may provide, to a second network node, a data channel service request that indicates the data channel application identifier, as described above.

As further shown in FIG. 8, in some aspects, process 800 may include obtaining, from the second network node, a service response comprising a data channel control policy associated with the data channel application identifier (block 830). For example, the first network node (e.g., using communication manager 1208 and/or reception component 1202, depicted in FIG. 12) may obtain, from the second network node, a service response comprising a data channel control policy associated with the data channel application identifier, as described above.

As further shown in FIG. 8, in some aspects, process 800 may include allocating, based at least in part on the data channel control policy, media resources corresponding to at least one application data channel and associated with the first user equipment and the second user equipment (block 840). For example, the first network node (e.g., using communication manager 1208, reception component 1202, and/or transmission component 1204, depicted in FIG. 12) may allocate, based at least in part on the data channel control policy, media resources corresponding to at least one application data channel and associated with the first user equipment and the second user equipment, as described above.

Process 800 may include additional aspects, such as any single aspect or any combination of aspects described below and/or in connection with one or more other processes described elsewhere herein.

In a first aspect, process 800 includes providing the data channel establishment request to a terminating application server. In a second aspect, alone or in combination with the first aspect, process 800 includes facilitating establishment of the at least one application data channel between the first user equipment and the second user equipment. In a third aspect, alone or in combination with the second aspect, the at least one application data channel comprises a first application data channel between the first user equipment and the second network node and a second application data channel between the second network node and the second user equipment. In a fourth aspect, alone or in combination with one or more of the second or third aspects, the at least one application data channel comprises a first application data channel between the first user equipment and an application server and a second application data channel between the application server and the second user equipment.

In a fifth aspect, alone or in combination with one or more of the first through fourth aspects, the first network node comprises an internet protocol multimedia subsystem application server. In a sixth aspect, alone or in combination with one or more of the first through fifth aspects, process 800 includes facilitating establishment of a bootstrap data channel between the first user equipment and the second network node, and providing, using the bootstrap data channel, a first instance of the data channel application to the first user equipment.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a first network node, in accordance with the present disclosure. Example process 900 is an example where the first network node (e.g., first network node DChS 710) performs operations associated with data channel communications associated with an IMS.

As shown in FIG. 9, in some aspects, process 900 may include obtaining, from a second network node, a data channel application identifier corresponding to a data channel application associated with a multimedia call session between a first user equipment and a second user equipment (block 910). For example, the first network node (e.g., using communication manager 1208 and/or reception component 1202, depicted in FIG. 12) may obtain, from a second network node, a data channel application identifier corresponding to a data channel application associated with a multimedia call session between a first user equipment and a second user equipment, as described above.

As further shown in FIG. 9, in some aspects, process 900 may include providing, to the first user equipment, the data channel application identifier based on the first user equipment obtaining a first instance of the data channel application (block 920). For example, the first network node (e.g., using communication manager 1208 and/or transmission component 1204, depicted in FIG. 12) may provide, to the first user equipment, the data channel application identifier based on the first user equipment obtaining a first instance of the data channel application, as described above.

Process 900 may include additional aspects, such as any single aspect or any combination of aspects described below and/or in connection with one or more other processes described elsewhere herein.

In a first aspect, process 900 includes providing, to the second user equipment, the data channel application identifier based on the second user equipment obtaining a first instance of the data channel application. In a second aspect, alone or in combination with the first aspect, process 900 includes obtaining, from the second network node, a data channel service request that indicates the data channel application identifier, and providing, to the second network node, a service response comprising a data channel control policy associated with the data channel application identifier.

In a third aspect, alone or in combination with one or more of the first and second aspects, process 900 includes obtaining, from a third network node, a data channel service request that indicates the data channel application identifier, and providing, to the third network node, a service response comprising a data channel control policy associated with the data channel application identifier. In a fourth aspect, alone or in combination with one or more of the first through third aspects, the first network node comprises a data channel server.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a first user equipment, in accordance with the present disclosure. Example process 1000 is an example where the first user equipment (e.g., the UE 702) performs operations associated with data channel communications associated with an IMS.

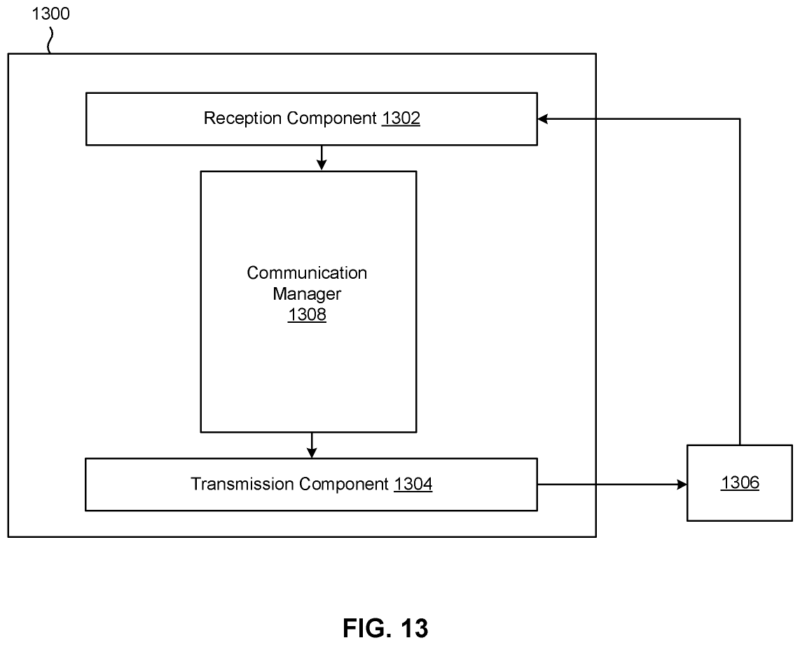

As shown in FIG. 10, in some aspects, process 1000 may include providing, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment (block 1010). For example, the first user equipment (e.g., using communication manager 1308 and/or transmission component 1304, depicted in FIG. 13) may provide, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment, as described above.

As further shown in FIG. 10, in some aspects, process 1000 may include obtaining, from the first network node, an allocation of media resources corresponding to at least one application data channel and associated with the first user equipment and the second user equipment, wherein the allocation is based on a data channel control policy associated with the data channel application identifier (block 1020). For example, the first user equipment (e.g., using communication manager 1308 and/or reception component 1302, depicted in FIG. 13) may obtain, from the first network node, an allocation of media resources corresponding to at least one application data channel and associated with the first user equipment and the second user equipment, wherein the allocation is based on a data channel control policy associated with the data channel application identifier, as described above.

Process 1000 may include additional aspects, such as any single aspect or any combination of aspects described below and/or in connection with one or more other processes described elsewhere herein.

In a first aspect, process 1000 includes facilitating establishment of the at least one application data channel between the first user equipment and the second user equipment. In a second aspect, alone or in combination with the first aspect, the at least one application data channel comprises a first application data channel between the first user equipment and a second network node and a second application data channel between the second network node and the second user equipment. In a third aspect, alone or in combination with one or more of the first and second aspects, the at least one application data channel comprises a first application data channel between the first user equipment and an application server and a second application data channel between the application server and the second user equipment. In a fourth aspect, alone or in combination with one or more of the first through third aspects, the first network node comprises an internet protocol multimedia subsystem application server.

In a fifth aspect, alone or in combination with one or more of the first through fourth aspects, process 1000 includes obtaining, via a bootstrap data channel between the first user equipment and the first network node, a first instance of the data channel application. In a sixth aspect, alone or in combination with one or more of the first through fifth aspects, process 1000 includes communicating data channel traffic via the at least one application data channel, and associating the data channel traffic with the data channel application identifier.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a second user equipment, in accordance with the present disclosure. Example process 1100 is an example where the second user equipment (e.g., the UE 704) performs operations associated with data channel communications associated with an IMS.

As shown in FIG. 11, in some aspects, process 1100 may include obtaining, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment (block 1110). For example, the second user equipment (e.g., using communication manager 1308 and/or reception component 1302, depicted in FIG. 13) may obtain, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment, as described above.

As further shown in FIG. 11, in some aspects, process 1100 may include communicating data channel traffic via at least one application data channel between the first user equipment and the second user equipment (block 1120). For example, the second user equipment (e.g., using communication manager 1308, reception component 1302, and/or transmission component 1304, depicted in FIG. 13) may communicate data channel traffic via at least one application data channel between the first user equipment and the second user equipment, as described above.

As further shown in FIG. 11, in some aspects, process 1100 may include associating the data channel traffic with the data channel application identifier (block 1130). For example, the second user equipment (e.g., using communication manager 1308, reception component 1302, and/or transmission component 1304, depicted in FIG. 13) may associate the data channel traffic with the data channel application identifier, as described above.

Process 1100 may include additional aspects, such as any single aspect or any combination of aspects described below and/or in connection with one or more other processes described elsewhere herein.

In a first aspect, process 1100 includes providing, to a second network node, a request to download an instance of the data channel application, and obtaining, via a bootstrap data channel between the second user equipment and the second network node, the instance of the data channel application. In a second aspect, alone or in combination with the first aspect, the at least one application data channel comprises a first application data channel between the first user equipment and a second network node and a second application data channel between the second network node and the second user equipment. In a third aspect, alone or in combination with one or more of the first and second aspects, the at least one application data channel comprises a first application data channel between the first user equipment and an application server and a second application data channel between the application server and the second user equipment.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a communication manager 1208.

In some aspects, the apparatus 1200 may be configured to perform one or more operations described herein in connection with FIG. 7. Additionally, or alternatively, the apparatus 1200 may be configured to perform one or more processes described herein, such as process 800 of FIG. 8, process 900 of FIG. 9, or a combination thereof. In some aspects, the apparatus 1200 and/or one or more components shown in FIG. 12 may include one or more components of the network node described in connection with FIG. 4 and/or the apparatus described in connection with FIG. 2. Additionally, or alternatively, one or more components shown in FIG. 12 may be implemented within one or more components described in connection with FIG. 2 and/or FIG. 4. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 4 and/or the apparatus described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 4 and/or the apparatus described in connection with FIG. 2. In some aspects, the transmission component 1204 may be co-located with the reception component 1202 in a transceiver.

The communication manager 1208 and/or the reception component 1202 may obtain a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment.

In some aspects, the communication manager 1208 may include one or more antennas, a modem, a controller/processor, a memory, or a combination thereof, of the network node described in connection with FIG. 4 and/or the apparatus described in connection with FIG. 2. In some aspects, the communication manager 1208 may include the reception component 1202 and/or the transmission component 1204. In some aspects, the communication manager 1208 may be, be similar to, include, or be included in, the communication manager 460 depicted in FIG. 4, the communication manager 350 depicted in FIG. 3, the communication manager 235 depicted in FIG. 2, and/or the communication manager 106 depicted in FIG. 1.

The communication manager 1208 and/or the transmission component 1204 may provide, to a second network node, a data channel service request that indicates the data channel application identifier. The communication manager 1208 and/or the reception component 1202 may obtain, from the second network node, a service response comprising a data channel control policy associated with the data channel application identifier. The communication manager 1208, the reception component, and/or the transmission component 1204 may allocate, based at least in part on the data channel control policy, media resources corresponding to at least one application data channel and associated with the first user equipment and the second user equipment.

The communication manager 1208 and/or the transmission component 1204 may provide the data channel establishment request to a terminating application server. The communication manager 1208, the reception component, and/or the transmission component 1204 may facilitate establishment of the at least one application data channel between the first user equipment and the second user equipment. The communication manager 1208, the reception component, and/or the transmission component 1204 may facilitate establishment of a bootstrap data channel between the first user equipment and the second network node. The communication manager 1208 and/or the transmission component 1204 may provide, using the bootstrap data channel, a first instance of the data channel application to the first user equipment.

The communication manager 1208 and/or the reception component 1202 may obtain, from a second network node, a data channel application identifier corresponding to a data channel application associated with a multimedia call session between a first user equipment and a second user equipment. The communication manager 1208 and/or the transmission component 1204 may provide, to the first user equipment, the data channel application identifier based on the first user equipment obtaining a first instance of the data channel application.

The communication manager 1208 and/or the transmission component 1204 may provide, to the second user equipment, the data channel application identifier based on the second user equipment obtaining a first instance of the data channel application. The communication manager 1208 and/or the reception component 1202 may obtain, from the second network node, a data channel service request that indicates the data channel application identifier. The communication manager 1208 and/or the transmission component 1204 may provide, to the second network node, a service response comprising a data channel control policy associated with the data channel application identifier.

The communication manager 1208 and/or the reception component 1202 may obtain, from a third network node, a data channel service request that indicates the data channel application identifier. The communication manager 1208 and/or the transmission component 1204 may provide, to the third network node, a service response comprising a data channel control policy associated with the data channel application identifier.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308.

In some aspects, the apparatus 1300 may be configured to perform one or more operations described herein in connection with FIG. 7. Additionally, or alternatively, the apparatus 1300 may be configured to perform one or more processes described herein, such as process 1000 of FIG. 10, process 1100 of FIG. 11, or a combination thereof. In some aspects, the apparatus 1300 and/or one or more components shown in FIG. 13 may include one or more components of the UE described in connection with FIG. 4 and/or the apparatus described in connection with FIG. 2. Additionally, or alternatively, one or more components shown in FIG. 13 may be implemented within one or more components described in connection with FIG. 2 and/or FIG. 4. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 4 and/or the apparatus described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 4 and/or the apparatus described in connection with FIG. 2. In some aspects, the transmission component 1304 may be co-located with the reception component 1302 in a transceiver.

The communication manager 1308 and/or the transmission component 1304 may provide, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment.

In some aspects, the communication manager 1308 may include one or more antennas, a modem, a controller/processor, a memory, or a combination thereof, of the UE described in connection with FIG. 4 and/or the apparatus described in connection with FIG. 2. In some aspects, the communication manager 1308 may include the reception component 1302 and/or the transmission component 1304. In some aspects, the communication manager 1308 may be, be similar to, include, or be included in, the communication manager 458 depicted in FIG. 4, the communication manager 340 depicted in FIG. 3, the communication manager 235 depicted in FIG. 2, and/or the communication manager 106 depicted in FIG. 1.

The communication manager 1308 and/or the reception component 1302 may obtain, from the first network node, an allocation of media resources corresponding to at least one application data channel and associated with the first user equipment and the second user equipment, wherein the allocation is based on a data channel control policy associated with the data channel application identifier. The communication manager 1308, the reception component 1302, and/or the transmission component 1304 may facilitate establishment of the at least one application data channel between the first user equipment and the second user equipment. The communication manager 1308 and/or the reception component 1302 may obtain, via a bootstrap data channel between the first user equipment and the first network node, a first instance of the data channel application. The communication manager 1308, the reception component 1302, and/or the transmission component 1304 may communicate data channel traffic via the at least one application data channel. The communication manager 1308, the reception component 1302, and/or the transmission component 1304 may associate the data channel traffic with the data channel application identifier.

The communication manager 1308 and/or the reception component 1302 may obtain, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment. The communication manager 1308, the reception component 1302, and/or the transmission component 1304 may communicate data channel traffic via at least one application data channel between the first user equipment and the second user equipment. The communication manager 1308, the reception component 1302, and/or the transmission component 1304 may associate the data channel traffic with the data channel application identifier.

The communication manager 1308 and/or the transmission component 1304 may provide, to a second network node, a request to download an instance of the data channel application. The communication manager 1308 and/or the reception component 1302 may obtain, via a bootstrap data channel between the second user equipment and the second network node, the instance of the data channel application.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a first network node, comprising: obtaining a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment; providing, to a second network node, a data channel service request that indicates the data channel application identifier; obtaining, from the second network node, a service response comprising a data channel control policy associated with the data channel application identifier; and allocating, based at least in part on the data channel control policy, media resources corresponding to at least one application data channel and associated with the first user equipment and the second user equipment.

Aspect 2: The method of Aspect 1, further comprising providing the data channel establishment request to a terminating application server.

Aspect 3: The method of either of Aspects 1 or 2, further comprising facilitating establishment of the at least one application data channel between the first user equipment and the second user equipment.

Aspect 4: The method of Aspect 3, wherein the at least one application data channel comprises a first application data channel between the first user equipment and the second network node and a second application data channel between the second network node and the second user equipment.

Aspect 5: The method of either of Aspects 3 or 4, wherein the at least one application data channel comprises a first application data channel between the first user equipment and an application server and a second application data channel between the application server and the second user equipment.

Aspect 6: The method of any of Aspects 1-5, wherein the first network node comprises an internet protocol multimedia subsystem application server.

Aspect 7: The method of any of Aspects 1-6, further comprising: facilitating establishment of a bootstrap data channel between the first user equipment and the second network node; and providing, using the bootstrap data channel, a first instance of the data channel application to the first user equipment.

Aspect 8: A method of wireless communication performed by a first network node, comprising: obtaining, from a second network node, a data channel application identifier corresponding to a data channel application associated with a multimedia call session between a first user equipment and a second user equipment; and providing, to the first user equipment, the data channel application identifier based on the first user equipment obtaining a first instance of the data channel application.

Aspect 9: The method of Aspect 8, further comprising providing, to the second user equipment, the data channel application identifier based on the second user equipment obtaining a first instance of the data channel application.

Aspect 10: The method of either of Aspects 8 or 9, further comprising: obtaining, from the second network node, a data channel service request that indicates the data channel application identifier; and providing, to the second network node, a service response comprising a data channel control policy associated with the data

Aspect 11: The method of any of Aspects 8-10, further comprising: obtaining, from a third network node, a data channel service request that indicates the data channel application identifier; and providing, to the third network node, a service response comprising a data channel control policy associated with the data channel application identifier.

Aspect 12: The method of any of Aspects 8-11, wherein the first network node comprises a data channel server.

Aspect 13: A method of wireless communication performed by a first user equipment, comprising: providing, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment; and obtaining, from the first network node, an allocation of media resources corresponding to at least one application data channel and associated with the first user equipment and the second user equipment, wherein the allocation is based on a data channel control policy associated with the data channel application identifier.

Aspect 14: The method of Aspect 13, further comprising facilitating establishment of the at least one application data channel between the first user equipment and the second user equipment.

Aspect 15: The method of Aspect 14, wherein the at least one application data channel comprises a first application data channel between the first user equipment and a second network node and a second application data channel between the second network node and the second user equipment.

Aspect 16: The method of either of Aspects 14 or 15, wherein the at least one application data channel comprises a first application data channel between the first user equipment and an application server and a second application data channel between the application server and the second user equipment.

Aspect 17: The method of any of Aspects 13-16, wherein the first network node comprises an internet protocol multimedia subsystem application server.

Aspect 18: The method of any of Aspects 13-17, further comprising obtaining, via a bootstrap data channel between the first user equipment and the first network node, a first instance of the data channel application.

Aspect 19: The method of any of Aspects 13-18, further comprising: communicating data channel traffic via the at least one application data channel; and associating the data channel traffic with the data channel application identifier.

Aspect 20: A method of wireless communication performed by a second user equipment and associated with a multimedia call session between a first user equipment and the second user equipment, comprising: obtaining, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment; communicating data channel traffic via at least one application data channel between the first user equipment and the second user equipment; and associating the data channel traffic with the data channel application identifier.

Aspect 21: The method of Aspect 20, further comprising: providing, to a second network node, a request to download an instance of the data channel application; and obtaining, via a bootstrap data channel between the second user equipment and the second network node, the instance of the data channel application.

Aspect 22: The method of either of Aspects 20 or 21, wherein the at least one application data channel comprises a first application data channel between the first user equipment and a second network node and a second application data channel between the second network node and the second user equipment.

Aspect 23: The method of any of Aspects 20-22, wherein the at least one application data channel comprises a first application data channel between the first user equipment and an application server and a second application data channel between the application server and the second user equipment.

Aspect 24: An apparatus for wireless communication at a device, comprising a processor; memory coupled with the processor; and instructions stored in the memory and executable by the processor to cause the apparatus to perform the method of one or more of Aspects 1-7.

Aspect 25: A device for wireless communication, comprising a memory and one or more processors coupled to the memory, the one or more processors configured to perform the method of one or more of Aspects 1-7.

Aspect 26: An apparatus for wireless communication, comprising at least one means for performing the method of one or more of Aspects 1-7.

Aspect 27: A non-transitory computer-readable medium storing code for wireless communication, the code comprising instructions executable by a processor to perform the method of one or more of Aspects 1-7.

Aspect 28: A non-transitory computer-readable medium storing a set of instructions for wireless communication, the set of instructions comprising one or more instructions that, when executed by one or more processors of a device, cause the device to perform the method of one or more of Aspects 1-7.

Aspect 29: An apparatus for wireless communication at a device, comprising a processor; memory coupled with the processor; and instructions stored in the memory and executable by the processor to cause the apparatus to perform the method of one or more of Aspects 8-12.

Aspect 30: A device for wireless communication, comprising a memory and one or more processors coupled to the memory, the one or more processors configured to perform the method of one or more of Aspects 8-12.

Aspect 31: An apparatus for wireless communication, comprising at least one means for performing the method of one or more of Aspects 8-12.

Aspect 32: A non-transitory computer-readable medium storing code for wireless communication, the code comprising instructions executable by a processor to perform the method of one or more of Aspects 8-12.

Aspect 33: A non-transitory computer-readable medium storing a set of instructions for wireless communication, the set of instructions comprising one or more instructions that, when executed by one or more processors of a device, cause the device to perform the method of one or more of Aspects 8-12.

Aspect 34: An apparatus for wireless communication at a device, comprising a processor; memory coupled with the processor; and instructions stored in the memory and executable by the processor to cause the apparatus to perform the method of one or more of Aspects 13-19.

Aspect 35: A device for wireless communication, comprising a memory and one or more processors coupled to the memory, the one or more processors configured to perform the method of one or more of Aspects 13-19.

Aspect 36: An apparatus for wireless communication, comprising at least one means for performing the method of one or more of Aspects 13-19.

Aspect 37: A non-transitory computer-readable medium storing code for wireless communication, the code comprising instructions executable by a processor to perform the method of one or more of Aspects 13-19.

Aspect 38: A non-transitory computer-readable medium storing a set of instructions for wireless communication, the set of instructions comprising one or more instructions that, when executed by one or more processors of a device, cause the device to perform the method of one or more of Aspects 13-19.

Aspect 39: An apparatus for wireless communication at a device, comprising a processor; memory coupled with the processor; and instructions stored in the memory and executable by the processor to cause the apparatus to perform the method of one or more of Aspects 20-23.

Aspect 40: A device for wireless communication, comprising a memory and one or more processors coupled to the memory, the one or more processors configured to perform the method of one or more of Aspects 20-23.

Aspect 41: An apparatus for wireless communication, comprising at least one means for performing the method of one or more of Aspects 20-23.

Aspect 42: A non-transitory computer-readable medium storing code for wireless communication, the code comprising instructions executable by a processor to perform the method of one or more of Aspects 20-23.

Aspect 43: A non-transitory computer-readable medium storing a set of instructions for wireless communication, the set of instructions comprising one or more instructions that, when executed by one or more processors of a device, cause the device to perform the method of one or more of Aspects 20-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first network node for wireless communication, comprising:
a memory; and
one or more processors, coupled to the memory, configured to:
obtain a data channel establishment request comprising session description protocol information corresponding to a multimedia call session between a first user equipment and a second user equipment, the session description protocol information indicating media description information associated with the multimedia call session, wherein the media description information includes a data channel application identifier corresponding to a data channel application associated with the first user equipment;
provide, to a second network node, a data channel service request that indicates the data channel application identifier;
obtain, from the second network node, a service response comprising a data channel control policy associated with the data channel application identifier; and
allocate, based at least in part on the data channel control policy, media resources corresponding to at least one application data channel and associated with the first user equipment and the second user equipment.

2. The first network node of claim 1, wherein the one or more processors are further configured to provide the data channel establishment request to a terminating application server.

3. The first network node of claim 1, wherein the one or more processors are further configured to facilitate establishment of the at least one application data channel between the first user equipment and the second user equipment.

4. The first network node of claim 3, wherein the at least one application data channel comprises a first application data channel between the first user equipment and the second network node and a second application data channel between the second network node and the second user equipment.

5. The first network node of claim 3, wherein the at least one application data channel comprises a first application data channel between the first user equipment and an application server and a second application data channel between the application server and the second user equipment.

6. The first network node of claim 1, wherein the first network node comprises an internet protocol multimedia subsystem application server.

7. The first network node of claim 1, wherein the one or more processors are further configured to:
facilitate establishment of a bootstrap data channel between the first user equipment and the second network node; and
provide, using the bootstrap data channel, a first instance of the data channel application to the first user equipment.

8. A first network node for wireless communication, comprising:
a memory; and
one or more processors, coupled to the memory, configured to:
obtain, from a second network node, a data channel application identifier corresponding to a data channel application associated with a multimedia call session between a first user equipment and a second user equipment; and
provide, to the first user equipment, the data channel application identifier based on the first user equipment obtaining a first instance of the data channel application.

9. The first network node of claim 8, wherein the one or more processors are further configured to provide, to the second user equipment, the data channel application identifier based on the second user equipment obtaining a first instance of the data channel application.

10. The first network node of claim 8, wherein the one or more processors are further configured to:
obtain, from the second network node, a data channel service request that indicates the data channel application identifier; and
provide, to the second network node, a service response comprising a data channel control policy associated with the data channel application identifier.

11. The first network node of claim 8, wherein the one or more processors are further configured to:
obtain, from a third network node, a data channel service request that indicates the data channel application identifier; and
provide, to the third network node, a service response comprising a data channel control policy associated with the data channel application identifier.

12. The first network node of claim 8, wherein the first network node comprises a data channel server.

13. A first user equipment for wireless communication, comprising:
a memory; and
one or more processors, coupled to the memory, configured to:
provide, to a first network node, a data channel establishment request comprising session description protocol information corresponding to a multimedia call session between the first user equipment and a second user equipment, the session description protocol information indicating media description information associated with the multimedia call session, wherein the media description information includes a data channel application identifier corresponding to a data channel application associated with the first user equipment; and
obtain, from the first network node, an allocation of media resources corresponding to at least one application data channel and associated with the first user equipment and the second user equipment, wherein the allocation is based on a data channel control policy associated with the data channel application identifier.

14. The first user equipment of claim 13, wherein the one or more processors are further configured to facilitate establishment of the at least one application data channel between the first user equipment and the second user equipment.

15. The first user equipment of claim 14, wherein the at least one application data channel comprises a first application data channel between the first user equipment and a second network node and a second application data channel between the second network node and the second user equipment.

16. The first user equipment of claim 14, wherein the at least one application data channel comprises a first application data channel between the first user equipment and an application server and a second application data channel between the application server and the second user equipment.

17. The first user equipment of claim 13, wherein the first network node comprises an internet protocol multimedia subsystem application server.

18. The first user equipment of claim 13, wherein the one or more processors are further configured to obtain, via a bootstrap data channel between the first user equipment and the first network node, a first instance of the data channel application.

19. The first user equipment of claim 13, wherein the one or more processors are further configured to:
communicate data channel traffic via the at least one application data channel; and
associate the data channel traffic with the data channel application identifier.

20. A second user equipment associated with a multimedia call session between a first user equipment and the second user equipment, comprising:
a memory; and
one or more processors, coupled to the memory, configured to:
obtain, from a first network node, a data channel service request comprising session description protocol information corresponding to the multimedia call session, the session description protocol information indicating media description information associated with the multimedia call session, wherein the media description information includes a data channel application identifier corresponding to a data channel application associated with the first user equipment;
communicate data channel traffic via at least one application data channel between the first user equipment and the second user equipment; and
associate the data channel traffic with the data channel application identifier.

21. The second user equipment of claim 20, wherein the one or more processors are further configured to:
provide, to a second network node, a request to download an instance of the data channel application; and
obtain, via a bootstrap data channel between the second user equipment and the second network node, the instance of the data channel application.

22. The second user equipment of claim 20, wherein the at least one application data channel comprises a first application data channel between the first user equipment and a second network node and a second application data channel between the second network node and the second user equipment.

23. The second user equipment of claim 20, wherein the at least one application data channel comprises a first application data channel between the first user equipment and an application server and a second application data channel between the application server and the second user equipment.
